(19) United States
(12) Patent Application Publication
(10) Pub. No.: US 2025/0219140 A1
(43) Pub. Date: Jul. 3, 2025

(54) LI-ION-CONDUCTING POLYMER AND POLYMER-CERAMIC ELECTROLYTES FOR SOLID STATE BATTERIES

(71) Applicant: THE REGENTS OF THE UNIVERSITY OF CALIFORNIA, Oakland, CA (US)

(72) Inventor: Huolin Xin, Irvine, CA (US)

(21) Appl. No.: 18/878,823

(22) PCT Filed: Jun. 27, 2023
(86) PCT No.: PCT/US2023/069170

§ 371 Date: Dec. 24, 2024

Related U.S. Application Data
(60) Provisional application No. 63/355,816, filed on Jun. 27, 2022.

(51) Int. Cl. H01M 10/0565; H01M 10/052; H01M 10/0562; H01M 10/42

(52) U.S. Cl. CPC H01M 10/0565; H01M 10/052; H01M 10/0562; H01M 10/4235; H01M 2300/0068; H01M 2300/0082; H01M 2300/0094

(57) ABSTRACT

Solid state batteries having a solid polymer electrolyte (SPE) that replaces a liquid electrolyte between the negative and positive electrode. The SPE is the reaction product of a one-pot polymerization involving a polymer backbone, a Li salt, a plasticizer, and electrolyte additive(s). The electrolyte additive may resolve the anode/electrolyte interfacial corrosive reaction issues to prevent shorting. The negative electrode may be plated with the SPE in the form of an interphase film, which also acts to separate the negative electrode from the positive electrode.

### CROSS-REFERENCE TO RELATED APPLICATIONS

This application claims benefit of U.S. Provisional Application No. 63/355,816 filed Jun. 27, 2022, the specification(s) of which is/are incorporated herein in their entirety by reference.

### STATEMENT REGARDING FEDERALLY SPONSORED RESEARCH OR DEVELOPMENT

This invention was made with government support under Grant No. DE-SC0021204 awarded by U.S. Department of Energy. The government has certain rights in the invention.

### FIELD OF THE INVENTION

The present invention relates to solid state batteries, namely, to a solid polymer electrolyte for long-cycle-life Li-ion and Li-metal-anode batteries. The present invention describes a novel chemistry/structure/architecture for the polymer electrolyte separator that enables the safe and long cycle life operation of a family of rechargeable or primary solid state batteries. The family of solid state batteries includes, but is not limited to, those that use low-potential anodes such as lithium (Li) metal, graphite or silicon or combinations of them. The cathode includes both lower voltage as well as high voltage cathodes including, but not limited to, LiCoO₂, LiNiMnCoO₂, LiFePO₄, or their derivatives.

### BACKGROUND OF THE INVENTION

A traditional battery is made of an anode (the negative electrode), a cathode (the positive electrode), a separator, and a liquid electrolyte that can conduct ions. A solid state battery replaces the liquid electrolyte by a solid-form electrolyte, also known as a solid electrolyte or solid electrolyte separator. The solid electrolyte needs to be able to conduct ions and be electronically insulated, i.e., it only conducts ions and not electrons. A side from the ion conductive property, a few other properties are required for forming a well-performing solid state battery. That includes 1) the ability to form low-impedance interphases with the anode and the cathode without the need of high stacking pressure; 2) the ability to prevent continued side reaction with the anode/cathode; and 3) sufficient mechanical strength to inhibit Li-metal anode's dendritic penetration or volume expansion of traditional anodes/cathodes.

Lithium metal (Li⁰), which holds a specific capacity of 3860 mAh g⁻¹ and a volumetric capacity of 2061 mAh cm⁻³, has been hailed as the most promising anode materials for next generation lithium batteries, whose implement can boost both the gravimetric and volumetric energy density of as-constructed lithium metal batteries (LMBs) in comparison with current lithium-ion batteries. Solid-state lithium-metal (Li⁰) batteries are gaining more traction for electric vehicle applications because they replace the flammable liquid electrolyte with a safer, solid-form electrolyte that offers higher energy density and better resistance against Li dendrite formation. When further coupling the Li⁰ anode with a non-flammable solid-state electrolyte (SSE), the safety level of LMBs can be substantially improved.

Compared with inorganic solid electrolytes, lightweight solid polymer electrolytes (SPEs) can achieve higher energy density with easy processability to enable roll-to-roll fabrication, and are compatible with conventional manufacturing processes used for liquid electrolyte systems. In the past decades, the low conductivity of SPE has seen improvement through numerous approaches such as the polymer architecture design, the polymer in salt strategy, and the introduction of inorganic and organic plasticizers. The role of the plasticizer is to enhance the mobility of polymer chains as well as to provide an additional solvation effect to the lithium salt. Ionic liquids and polyethylene oxide (PEO) oligomers are two types of conventional plasticizers. However, ionic liquid has a low transference number problem and PEO oligomers are easily oxidized when coupled with high-energy cathodes such as LiCoO₂ (LCO) and LiNiₓMn_{y}Co_{1-x-y}O₂ (NMC) cathodes. In contrast, the plasticizer succinonitrile (SN, N≡C—CH₂—CH₂—C≡N) is a solid crystal. It has a negligible vapor pressure at room temperature, high solvation power for various lithium salts, and excellent anti-oxidation ability at high voltages. More importantly, SPEs with SN plasticizer can be tuned to deliver a high bulk conductivity of ˜1 mS/cm at the room temperature (r.t.). Although promising, SPEs exhibit electrochemical/chemical instability against the lithium metal (Li⁰), mediocre conductivity, and poorly understood Li⁰-SPE interphases that prevent the extensive application in real batteries.

Compared with polymeric SSEs, inorganic SSEs can deliver higher ionic conductivity, higher thermal stability, and higher mechanical strength that allow them to mechanically block Li dendrites to further lower the safety risk of solid-state LMBs. In the past decades, a considerable number of lithium-ion conductors (LICs) have been discovered and investigated as potential inorganic SSEs, including lithium phosphorous oxynitride (LiPON), sodium super ionic conductor (NASICON)-, (anti) perovskite-, garnet-, halide-, and sulfide-based LICs. Although promising, most LICs exhibit a limited electrochemical stability window and are particularly not thermodynamically stable against Li metal. For example, the NASICON materials, such as LATP and LAGP, are thermodynamically stable up to ˜4.3 V (vs. Li⁺/Li), which unfortunately will be easily reduced below 2 V (vs. Li⁺/Li). In comparison, the garnet-based LICs, e.g., LiLaZrO (LLZO) and LiLaZrTiO (LLZTO), have the best resistance against the Li reduction with a calculated reduction potential of as low as 0.05 V (vs. Li⁺/Li), but exhibit a low oxidation potential of around 2.9 V (vs. Li⁺/Li) and involve the rare-earth La metal that negates the SSEs' sustainability.

The “reactive” behaviors of inorganic SSEs within the common operation voltage range of LMBs lead to a decomposition interphase at both the anode-SSE interface and the cathode-SSE interface (FIG. 36A). Such decomposition interphase layers usually display sluggish ionic transportation kinetics and are not dense, thereby dramatically increasing the interfacial resistance and causing a large overpotential. More importantly, if the decomposition interphase layer is both ionic and electronic conductive (namely forming a mixed ionic/electronic conductor, MIEC), e.g., LATP-derived reduction products, it will not only promote the continuous decomposition reaction of SSE from surface into the bulk, but also induce dendritic Li⁰ plating along the electronic conduction pathway. In an extreme situation that directly adopts MIECs as the SSE (FIG. 36B), the high electronic conductivity in bulk and/or the grain boundary of MIECs will result in more deadly Li dendrite formation within the SSE and/or at cathode-SSE interface, the latter of which will induce a destructive internal shorting of the cell. Therefore, mixed ionic/electronic conductors are traditionally considered impractical as SSEs in solid-state LMBs.

Current efforts have been primarily focused on mitigating the interfacial reactivity of LICs, such as by introducing protective coating layers. However, no attempt has been made to enable the employment of MIECs as SSE. Because many LICs based on earth-abundant metals (e.g., V, Al and Ti) are (electro) chemically unstable and/or electronically conductive, it is of both scientific and industrial importance to find a versatile solution to simultaneously address the SSE decomposition and internal Li⁰ plating issues for both reactive LICs- and MIECs-based SSEs. Relevant breakthroughs will potentially broaden the SSE choice for designing solid-state LMBs in a more sustainable way.

### BRIEF SUMMARY OF THE INVENTION

It is an objective of the present invention to provide batteries comprising solid polymer electrolytes (SPEs) and methods of synthesizing SPEs, as specified in the independent claims. Embodiments of the invention are given in the dependent claims. Embodiments of the present invention can be freely combined with each other if they are not mutually exclusive.

In some aspects, the present invention features a solid polymer electrolyte (SPE) that can replace the liquid electrolyte between the negative and positive electrode in a lithium-ion battery or a lithium-metal-anode battery. In some embodiments, the solid polymer architecture involves a polymer backbone, a Li salt, a salt ionizing and Li conducting plasticizer, and additives that solves the anode/electrolyte interfacial corrosive reaction issues. In some embodiments, the polymer backbone is poly (ethyl acrylate) or polyacrylonitrile. In some embodiments, the plasticizer is succinonitrile (SN, N≡C—CH₂—CH₂—C≡N). In some embodiments, the Li salt is LiTFSI. In some embodiments, the additives are fluoroethylene carbonate (FEC) or a mixture of FEC and VC.

According to some embodiments, the present invention features a solid state battery comprising an anode, a cathode, and the SPE. In some embodiments, the battery can be a lithium-ion battery or a lithium-metal-anode battery. In other embodiments, the anode may comprise Li metal, graphite, silicon, Li₄Ti₅O₁₂ or combinations thereof. In some other embodiments, the cathode may comprise LiFePO₄, LiCoO₂, LiNiₓMn_{y}Co_{1-x-y}O₂ (NMC) with x ranging from 0.33 to 1 and y ranging from 0 to 0.4, layered oxide cathodes, Li—Mn-rich cathodes, conversion cathodes, or derivatives thereof.

In some preferred embodiments, the SPE comprises a polymerized product of a polymer backbone comprising poly(ethylacrylate) or polyacrylonitrile, and a salt ionizing and Li conducting plasticizer comprising succinonitrile. In other embodiments, the SPE may further comprise an electrolyte additive. Non-limiting examples of the electrolyte additive include fluoroethylene carbonate (FEC), vinylene carbonate, or a combination of FEC and vinylene carbonate. In some other embodiments, the SPE may further comprise a Li salt. In a non-limiting embodiment, the Li salt is LiTFSI.

According to some embodiments, the present invention features a method of synthesizing the SPE for a solid state battery. The method may comprise providing a prepolymer mixture comprising i) a polymer precursor comprising ethylacrylate or acrylonitrile monomers, and ii) a plasticizer comprising succinonitrile, and polymerizing said prepolymer mixture to produce the SPE. In some embodiments, the step of polymerizing may comprise heating or photopolymerizing said prepolymer mixture.

According to other embodiments, the present invention features a solid-electrolyte interphase (SEI) film. The SEI film may comprise a polymerized product of a polymer backbone comprising poly(ethylacrylate) or polyacrylonitrile, and a salt ionizing and Li conducting plasticizer for a solid state battery comprising succinonitrile. In some embodiments, the SEI film may further comprise an electrolyte additive. Examples of the electrolyte additive include, but are not limited to, fluoroethylene carbonate (FEC), vinylene carbonate, or a combination of FEC and vinylene carbonate. In other embodiments, the SEI film may further comprise a Li salt, such as, for example, LiTFSI.

In some embodiments, the film may be disposed on a surface of an anode. For example, the anode may be plated with a solid-electrolyte interphase (SEI) film. Non-limiting examples of the anode include Li metal, graphite, silicon, Li₄Ti₅O₁₂ or combinations thereof. In some embodiments, the thickness of the SEI film ranges from about 1-30 nm.

According to other embodiments, the present invention features a method of producing an anode for a solid state battery. The method may comprise providing an anode material, and plating said anode material plated with any of the solid-electrolyte interphase (SEI) film described herein. In some embodiments, the thickness of the SEI film ranges from about 1-30 nm. In some embodiments, the anode is comprised of Li metal, graphite, silicon, Li₄Ti₅O₁₂ or combinations thereof.

According to another embodiment, the present invention features a solid electrolyte separator for a solid state battery. In one embodiment, the solid state battery may comprise an anode, a cathode, and the solid electrolyte separator. In some embodiments, the anode may comprise Li metal, graphite, silicon, Li₄Ti₅O₁₂ or combinations thereof. In other embodiments, the cathode may comprise Li⁰, LiFePO₄, LiCoO₂, LiNiₓMn_{y}Co_{1-x-y}O₂ (NMC) with x ranging from 0.33 to 1 and y ranging from 0 to 0.4, layered oxide cathodes, Li—Mn-rich cathodes, conversion cathodes, or derivatives thereof. In yet other embodiments, the cathode may comprise NMC-622 or NMC-811.

In some preferred embodiments, the separator may comprise a ceramic layer sandwiched between two polymer layers. The polymer layers may comprise a polymerized product of a polymer backbone comprising poly(ethylacrylate) or polyacrylonitrile, and a salt ionizing and Li conducting plasticizer comprising succinonitrile. In some embodiments, the polymer layers further comprise an electrolyte additive. Non-limiting examples of the electrolyte additive include fluoroethylene carbonate (FEC), vinylene carbonate, or a combination of FEC and vinylene carbonate. In other embodiments, the polymer layers may further comprise a Li salt, such as, for example, LiTFSI. In preferred embodiments, the polymer layers are electron-insulative.

According to some embodiments, the present invention features a method of synthesizing a solid electrolyte separator for a solid state battery. The method may comprise providing a prepolymer mixture comprising i) a polymer precursor comprising ethylacrylate or acrylonitrile monomers, ii) a crosslinker, and iii) a plasticizer comprising succinonitrile; polymerizing said prepolymer mixture to produce a polymer film; stacking a ceramic layer between two layers of the polymer film to form a stack; and applying a pressure onto the stack, thereby forming the solid electrolyte separator. Without wishing to limit the present invention, in some preferred embodiments, a pressure of less than 8 MPa is applied onto the stack. In other embodiments, the step of polymerizing the prepolymer mixture may comprise heating or photopolymerizing said mixture.

In some embodiments described herein, the ceramic layer has Li ion conductivity. In some embodiments, the ceramic layer may comprise any solid lithium ion conducting materials or solid mixed ionic electronic conductors. In some embodiments, the ceramic layer may comprise Li₁₊ₐAlₐTi₂₋ₐ(PO4)₃ (LATP) with 0≤a≤0.7, Li₁₊ₐAl_{b}Ge_{2-b}(PO₄)₃ with 0≤b≤1.5, LiV₃O₈ (LVO), Li_{7-c}La₃Zr₂O₁₂ (LLZO), Li_{7-c}La₃Zr_{2-c}Ta_{c}O₁₂ (LLZTO) with 0≤c≤2, LiOH, lithium nitride, lithium titanium oxide, lithium iron phosphate, Li₁₀GeP₂S₁₂ (LGPS), Li₇P₃S₁₁ (LPS), Li₆PS₅Cl, or derivatives or combinations thereof.

In this work, cryoEM imaging and spectroscopic techniques were applied on the complex structure and chemistry of the interface between Li⁰ and an SPE based on polyacrylate. Contrary to conventional knowledge, the inventors found that no protective interphase can be formed due to the sustained reactions between the deposited Li dendrites and the polyacrylic backbones as well as the succinonitrile plasticizer. Due to the reaction-induced volume change, large amounts of cracks were formed inside the Li dendrites with a stress corrosion cracking behavior indicating that Li⁰ cannot be passivated in this SPE system. Following this observation, the inventors introduced additive engineering and demonstrated that the Li⁰ surface can be effectively protected against corrosion leading to densely packed Li⁰ domes with conformal and stable solid-electrolyte interphases (SEIs) films. Owing to the high room temperature ionic conductivity of 1.01 mS/cm, the high transference number of 0.57 and the stabilized lithium-electrolyte interface, this improved new SPE delivers excellent lithium plating/stripping CE of 99% and 1800 hours of stable cycling in Li∥Li symmetric cells (0.2 mA/cm², 1 mAh/cm²). This improved cathodic stability along with the high anodic stability enables record high cycle life of >2000 cycles for Li∥LiFePO₄ and >400 cycles for Li∥LiCoO₂ full cells.

One of the unique and inventive technical features of the present invention is the use of poly (ethyl acrylate) or polyacrylonitrile with succinonitrile. SN has been used previously in solid polymer electrolytes for its ability to solvate and ionize Li salts and provide good conductivity at room temperature. However, the problem is that it is not compatible with graphite or Li metal anodes. Both poly (ethyl acrylate) and polyacrylonitrile have not previously been used as backbones for hosting SN plasticizer. By optimizing the combination of the two polymer backbones, a desired mechanical property can be achieved. In some embodiments, the solid polymer has a storage moduli ranging from about 200-300 MPa and a loss modulus in the 20-60 MPa range.

Without wishing to limit the present invention to a particular theory or mechanism, the key novelties of the present invention includes the identification of the additives that solves the interfacial problems in solid state batteries, the identification of the two families of polymer backbones that are compatible with the SN plasticizer that provides good mechanical properties, and the identification of polymers developed that are compatible with many Li-conducting inorganic solids so they can be used as buffer/insulating layers between the anode/cathode and the inorganic solid ionics. It is believed that the novel solid polymer architecture advantageously provide 1) good Li ion conductivity at room temperature, 2) good interfacial properties with the anode/cathode even at low pressures, and 3) good mechanical and interphase properties that can inhibit Li-metal anode's dendritic growth to prevent shorting. Furthermore, it allows for a much broader range of inorganic materials, for instance those that are not compatible with Li anode or high-voltage cathodes or those that conduct electrons, to be used in the solid-state separator in solid state batteries. None of the presently known prior references or work has the unique inventive technical feature of the present invention.

The commercial state-of-the-art solid polymer electrolytes are based on PEOs. PEO has many undesirable properties when used in solid state batteries, including very low Li ion conductivity at room temperature and low anodic stability, meaning that it oxidizes at a relatively low potential. For PEO to have sufficient conductivity, the temperature needs to be raised above 60° C. This is undesirable because it requires heating of the battery packs, which costs extra energy, and the elevated temperature also makes the cathode and anode degrade faster. The low anodic stability makes it incompatible with high voltage, high energy density cathodes such as LiCoO₂, LiNiMnCoO₂, etc. Compared to the state-of-the-art, the present invention is easy to fabricate and manufacture, has high room temperature conductivity (˜1 mS/cm), has good anodic stability up to 4.9V vs Li/Li+, and has good interphase with Li metal anode that has low impedance and low side reaction and allows smooth plating of Li.

In other embodiments, another novel and inventive technical feature of the present invention is the use of FEC or FEC+VC as additives. Without wishing to limit the invention to any theory or mechanism, it is believed that the technical feature of the present invention advantageously allows for the formation of conformal and thin solid electrolyte interphase (SEI) films that can protect and stabilize the Li-metal or the graphite anode. Furthermore, when FEC was added to the SN+LiTFSI, the Coulombic efficiency increased with FEC amounts from 0% to 5 wt %. None of the presently known prior references or work has this unique, inventive technical feature.

In addition to using the above-described polymers as the only constituent in the solid-state separator, another embodiment of the present invention utilizes the polymers in a sandwiched solid separator design. In some embodiments, the solid separator may comprise a 3-layer sandwich structure with the top and bottom layers being the polymers described above. The middle layer can be any ceramic material with the only requirement that they have some Li-ion conductivity.

Traditionally, there are several requirements for the selection of a solid ceramic separator for Li-metal and Li-ion batteries, such as: 1) the ceramic material needs to be an electronic insulator; 2) the ceramic material needs to be a Li ion conductor; and 3) the ceramic material either has an electrochemical window wider than the anode/cathode's operating potentials or a thin, passivating interphase can be formed to passivate the ceramic-anode/cathode interface. Without wishing to limit the present invention to a particular theory or mechanism, the novelty here is that the poly(ethyl acrylate) or polyacrylonitrile enabled sandwich structure can resolve the requirements of 1) and 3). It means that many materials that are electronically conductivity, or were previously incompatible with the anode/cathodes, can now be used in a solid separator for solid state batteries. This approach to broaden the selection of ceramic materials for solid state batteries has never been reported before and is novel.

In some embodiments, the present invention features a versatile SSE by sandwiching the inorganic LIC between two polymeric LIC layers. The polymer thin layer is electron-insulative and stable with Li⁰ anodes/cathodes (FIG. 36C), thus promising the application of sustainable yet reactive or electrically conductive LICs for solid-state LMBs. In addition, the soft polymer layer improves the contact between SSE and Li⁰ anodes/cathodes, which addresses the notorious large interfacial resistance of Li⁰/inorganic LICs and cathode/inorganic LICs. In some embodiments, the functional polymer layers are composed of polyEA (poly ethyl acrylate) as described herein.

By leveraging the above sandwich configuration, the present invention is able to demonstrate the reliability of Li_{1.5}Al_{0.5}Tl_{1.5}(PO₄)₃ (LATP) and LiV₃O₈ (LVO) in solid-state LMBs, where LATP and LVO are selected as a model system of reactive LICs and MIECs, respectively. The sandwich-type SSEs based on LATP and LVO show significantly reduced interfacial resistance and dense Li metal evolution morphology. Cryo-electron microscopy (EM) and X-ray photoelectron spectroscopy (XPS) further reveal that the detrimental decomposition of inorganic LICs at Li⁰/SSE interface can be eliminated by the introduction of polymer layers. Symmetric Li⁰//Li⁰ cells using the sandwich LATP-based SSE can stably run for over 6000h and 2500h at 0.1 mA cm⁻² and 0.5 mA cm⁻², respectively. Moreover, solid-state Li⁰/LiNi_{0.8}Mn_{0.1}Co_{0.1}O₂ (high cathode mass loading: 8 mA g⁻¹) batteries using both LATP- and LVO-based SSE exhibited excellent cycling stability for over 300 cycles test at room temperature. The high areal capacity Li⁰/LiNi_{0.8}Mn_{0.1}Co_{0.1}O₂ full cell also presented a negligible discharge capacity decay in the low N/P ratio (1.25) condition.

As a non-limiting example, Li_{1.5}Al_{0.5} Tl_{1.5}(PO₄)₃ (LATP) does not form a favorable interphase with Li anode and it also does not work well with high-voltage cathodes such as the NMC-622 and 811 cathodes. By sandwiching it between poly(ethyl acrylate) or polyacrylonitrile polymer electrolytes of the present invention, the Li∥sandwich∥NMC cells can have a long cycle life. In another example, LiVₓO_{y} (LVO) is electronically conductive so it is a mixed ionic electronic conductor. Traditionally, LVO cannot be used in a ceramic solid separator because it conducts electrons. However, by implementing the sandwich structure, LVO can be used in the solid separator. The present invention also demonstrated that other mixed ionic electronic conductors such as LiOH, lithium titanium oxide, lithium iron phosphate can be used in the sandwich structure. The Li∥sandwich∥NMC cells have long cycle life and good electrochemical performance.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIGS. 1A-1C is a model showing a ‘silver lining’ effect of a solid-electrolyte interphase (SEI) film and comparing with Li⁰ deposited under FEC-SPE. FIG. 1A is a digitally constructed volumetric model of Li dendrites without and without an outer SEI film. FIG. 1B shows a simulated Z-contrast STEM image of the Li dendrites with and without the SEI film. The SEI film shows a silver lining effect because the scattering power of oxygenated species is about 6 times higher than that of Li. FIG. 1C shows magnified images of the Li⁰ deposited under FEC-SPE showing the same ‘silver lining’ effect as pointed by the arrows.

FIGS. 2A-2D shows the structure and chemistry of the densely packed Li⁰ domes plated using FEC-added SPE (FEC-SPE). FIGS. 2A and 2B are cryogenic ADF-STEM images and EDS maps of the Li⁰ deposits. The enrichment of O, C, N, S, and F on the surface of the domes indicates the formation of dense and uniform SEI. FIG. 2C is a cryogenic atomic-resolution TEM image of the mosaic SEI composed of densely packed nano-sized domains with different crystallographic orientations. FIG. 2D shows the atomic structure of a Li₂O nanocrystal inside the SEI. The lattice spacing of the (111) plane of the Li₂O nanocrystal is denoted by the lines and arrows. The inset shows the fast Fourier transform (FFT) of the boxed region.

FIG. 3 shows atomic-resolution TEM images of the SEIs from different regions. Bragg spots in the ring patterns of the Fast Fourier transforms (FFTs) corresponding to these regions can be only assigned to Li₂O nanocrystals, suggesting that the lithium nitrides and lithium fluorides in the SEI are likely in a disordered state.

FIGS. 4A-4D show lithium stripping/plating Coulombic efficiency (CE) tested under the PNNL protocol for Li—Cu cells employing the SN-SPE (FIG. 4A), FEC-SPE-0.1 wt % (FIG. 4B), FEC-SPE-1 wt % (FIG. 4C), and FEC-SPE-2.5 wt % (FIG. 4D).

FIG. 5A shows EIS evolution of Li/SN-SPE/Li cell during cycling at 0.2 mA/cm² and 0.2 mAh/cm².

FIG. 5B shows the voltage-time profile of Li/SN-SPE/Li cell.

FIG. 6A shows EIS evolution of Li/FEC-SPE-0.1 wt %/Li cell during cycling at 0.2 mA/cm² and 0.2 mAh/cm².

FIG. 6B shows the voltage-time profile of Li/FEC-SPE-0.1 wt %/Li cell.

FIG. 7A shows EIS evolution of Li/FEC-SPE-1 wt %/Li cell during cycling at 0.2 mA/cm² and 0.2 mAh/cm².

FIG. 7B shows the voltage-time profile of Li/FEC-SPE-1 wt %/Li cell.

FIG. 8A shows EIS evolution of Li/FEC-SPE-2.5 wt %/Li cell during cycling at 0.2 mA/cm² and 0.2 mAh/cm².

FIG. 8B shows the voltage-time profile of Li/FEC-SPE-2.5 wt %/Li cell.

FIG. 9A shows EIS evolution of Li/FEC-SPE-5 wt %/Li cell during cycling at 0.2 mA/cm² and 0.2 mAh/cm².

FIG. 9B shows the voltage-time profile of Li/FEC-SPE-5 wt %/Li cell.

FIGS. 10A-10B show 1H NMR of SN-SPE (FIG. 10A) and FEC-SPE (FIG. 10B). CDCl₃ was employed as the deuterium solvent.

FIG. 11 shows SEM images showing the surface morphology of pristine lithium metal.

FIGS. 12A-12C show C 1s (FIG. 12A), O 1s (FIG. 12B), and Li 1s (FIG. 12CA) XPS profiles showing the surface chemistry of pristine lithium metal.

FIG. 13 shows photographs of a disassembled Li—Cu cell, the lithium metal anode, FEC-SPE, and Cu foil could be easily separated.

FIG. 14 is a schematic illustration and chemical structure showing the polymerization route of synthesized SPEs.

FIGS. 15A-15F show 3D morphology and chemistry of the Li-containing dendrites plated using the baseline SN-incorporated SPE (SN-SPE). FIG. 15A shows a cryogenic annular dark-field scanning transmission electron microscopy (ADF-STEM) image. FIG. 15B is a 3D reconstruction of a representative filament obtained by cryogenic tomography based on ADF-STEM images. FIG. 15C shows 3D cross-section analyses of the filament in FIG. 15A. FIG. 15D shows a cryogenic annular dark-field scanning transmission electron microscopy (ADF-STEM) image and energy-dispersive X-ray spectroscopy (EDS) maps of several filaments from different regions. FIG. 15E shows energy-dispersive X-ray spectroscopy (EDS) maps of several filaments from different regions. The results show that O, C, N, S, and F are distributed throughout the whole filament in all locations. FIG. 15F shows electron energy-loss spectroscopy (EELS) of the filament. C, N, and O species are identified in the spectra.

FIGS. 16A-16C show F1s, O1s, and C1s XPS spectra of FEC-SPE derived SEI with sputtering time of 0 and 10 minutes. LiF, Li₂O, and Li₂CO₃ were identified as SEI components.

FIGS. 16D and 16E show XPS quantitative analysis of the SEIs derived from FEC-SPE and SN-SPE. The FEC-SPE-derived SEI exhibits higher F content and higher S content.

FIG. 16F shows the critical current density of FEC-SPE tested with pristine lithium metal at 50° C. The Li∥SPE∥Li symmetric cell was cycled under step-up current densities, and no short circuit occurred before 3.2 mA/cm². The charge/discharge time was fixed at 0.5 hours.

FIG. 16G shows the lithium stripping/plating Coulombic efficiency (CE) tested under the PNNL protocol.

FIG. 16H shows EIS evolution when cycling a Li∥FEC-SPE∥Li cell at 0.1 mA/cm², 0.1 mAh/cm², and r. t. Low and constant charge transfer resistance was achieved after cycling for 18 hours.

FIGS. 17A-17C show F1s (FIG. 17A), C1s (FIG. 17B), and O1s (FIG. 17C) XPS profiles of SN-SPE derived SEI.

FIGS. 18A and 18B show N 1s XPS profiles of FEC-SPE derived SEI (FIG. 18A) and SN-SPE derived SEI (FIG. 18B).

FIG. 19 is a voltage-time profile of Li/SN-SPE/Cu cell when measuring the Coulombic efficiency (CE) using the PNNL protocol. The voltage rapidly increased to 5V due to the continuous side reactions between Li⁰ and SN, thus the CE cannot be measured.

FIG. 20 shows the Coulombic efficiencies of SN-SPE and FEC-SPE tested under the fully stripped condition. The assembled Li—Cu cells were tested at 0.2 mA/cm² and 1 mAh/cm². The cut-off voltage for charging is 1V.

FIG. 21 shows the voltage-time profile of Li/FEC-SPE/Li cell during EIS measurement in FIG. 16H.

FIGS. 22A-22J shows Li⁰ deposit morphology and electrochemical behavior of prepared SPEs under large area capacity conditions. FIG. 22A shows voltage-time curves and EIS evolution when constantly charging a Li∥FEC-SPE∥Li cell at 0.2 mAh/cm² for 18 hours. The declining overpotential in the first 4 hours was due to the SEI formation, as proven by the decreased R_{ct} and slightly increased bulk resistance (inset). FIG. 22B shows the Li⁺ transference number of FEC-SPE measured by the potentialstatic method under a Li∥FEC-SPE∥Li cell configuration and 22° C. Note that in order to accurately measure the transference number, the cell was first activated at 0.2 mA/cm² and 0.2 mAh/cm² to enable the SEI formation and achieve a stable interfacial resistance. Thus, the inserted EIS plots showed similar interfacial resistance before and after polarization. FIG. 22C shows the temperature-dependent ionic conductivity of FEC-SPE and the Arrhenius plot of the form

$$σ = {Ae}^{- \frac{{E}_{a}}{kT}} .$$

FIGS. 22D-22G are SEM images of 2 mAh/cm² Li⁰ deposited on Cu current collector from FEC-SPE (FIGS. 22D, 22E) and SN-SPE (FIGS. 22F, 22G) after discharging at 0.2 mA/cm² and 22° C. for 5 hours. FIG. 22H shows optical images of FEC-SPE and SN-SPE based in-situ cells. Dendritic morphology was observed for Li∥SN-SPE∥Li cells after charging at 1 mA/cm² for 6 hours. While the FEC-SPE has enabled uniform and smooth lithium plating. FIGS. 22I and 22J show the long-term cycling performance of Li—Li symmetric cells under 1 mAh/cm² and different current densities of 0.2 mA/cm² (FIG. 22I, 22° C.) and 1 mA/cm² (FIG. 22J, 50° C.).

FIG. 23 shows the electronic conductivity of FEC-SPE measured by the potentialstatic polarization method.

FIG. 24 is a comparison of room temperature conductivities of SN-SPE and FEC-SPE.

FIGS. 25A-25C show room temperature cycling stability of symmetric Li/FEC-SPE/Li cells under different conditions of 0.5 mA/cm² and 0.5 mAh/cm² (FIG. 25A), 1 mA/cm² and 0.5 mAh/cm² (FIG. 25B), and 0.5 mA/cm² and 1 mAh/cm² (FIG. 25C).

FIG. 26 is a stress-strain curve of SN-SPE and FEC-SPE measured by dynamic mechanical analysis.

FIGS. 27A-27B show storage modulus and loss modulus of SN-SPE (FIG. 27A) and FEC-SPE (FIG. 27B) measured by dynamic mechanical analysis.

FIG. 28 shows the molecular weight distribution of SN-SPE and FEC-SPE. Note that ethylene glycol dimethylacrylate crosslinker was not applied in order to obtain a soluble sample for gel permeation chromatography (GPC) measurement.

FIG. 29 shows the 1H NMR of ethylene acrylate monomer before polymerization, CDCl₃ was employed as the deuterium solvent.

FIGS. 30A-30G show the room temperature performance of FEC-SPE-based full cells employing different cathode materials, area capacities, and N/P ratios. FIG. 30A shows the cycling stability of Li∥FEC-SPE∥LFP cells at 0.5 C. The area mass loading of LFP is ˜2 mg/cm². FIG. 30B shows the charge-discharge curves of Li∥FEC-SPE∥LFP cell at 1^{st}, 500^{th}, 1000^{th}, 1500^{th}, and 2000^{th} cycles when cycling at 0.5 C. FIGS. 30C-30E show the long-term cycling stability, charge discharge curves, and rate capability of Li∥FEC-SPE∥LiCoO₂ cell at 22° C. The LiCoO₂ area loading is ˜5 mg/cm². FIG. 30F is the low N/P ratio cell performance with limited Li⁰ anode (2 mAh/cm²) and LiCoO₂ cathode (˜5 mg/cm²). The cell was cycled at 22° C. and 0.5 C. FIG. 30G is the cycling performance of FEC-SPE based solid-state cells with commercial high loading LiFePO₄ and LiNi_{0.8}Mn_{0.1} Co_{0.1}O₂ (NMC811) cathodes under Low N/P ratio conditions. The cells were cycled at 0.2 C and 22° C. with 5 mAh/cm² of Li⁰ as the anode.

FIG. 31A shows the cycling stability of Li/FEC-SPE/LFP cells at 1 C and RT.

FIGS. 31B and 31C show the rate capability (FIG. 31B) and charge-discharge curves (FIG. 31C) of Li/FEC-SPE/LFP cells at RT.

FIG. 32A shows the 1^{st} to 8^{th} CV scanning cycles of the Li/FEC-SPE/SS cell.

FIG. 32B is an enlarged CV profile of Li/FEC-SPE/SS cell at 2-4.6V.

FIGS. 33A and 33B show the LSV profiles of Li/FEC-SPE/SS (FIG. 33A) and Li/SN-SPE/SS (FIG. 33B) cells collected at a scanning rate of 1 mV/s.

FIGS. 34A and 34B show the rate capability (FIG. 34A) and 1 C cycling stability (FIG. 34B) of Li/FEC-SPE/NMC811 cells at RT.

FIG. 35 shows the Coulombic efficiencies of solid-state cells employing commercial high loading LiFePO₄ and NMC811 cathodes under Low N/P ratio conditions.

FIGS. 36A-36B show schematics of anode/cathode-solid state electrolyte (SSE) interphase evolution in solid-state batteries when using traditional undesired ceramic SSE. FIG. 36A show Li-ion conductors that are reactive with Li⁰ anode or cathode and FIG. 36B show mixed Li-ion and electron conductors.

FIG. 36C is a schematic of anode/cathode-SSE interphase evolution in solid-state batteries when using a sandwich-type SSE of the present invention.

FIG. 36D shows discharge/charge profiles of solid-state symmetric Li//Li cells, demonstrating the feasibility of both reactive LIC and MIEC (LATP, LVO, LiOH, LTO, and LFP) for SSE when adopting a sandwich configuration. The cycling current density was 0.5 mA cm⁻² and the cycling capacity was 1 mAh cm⁻².

FIG. 36E shows the electrochemical stability window and electronic conductivity of reactive LICs and MIECs demonstrated in this work.

FIGS. 37A and 37B show the impedance measurement (EIS) of Li//LATP//Li and Li//UVEA-LATP-UVEA//Li symmetric cells, respectively, at pristine state. While the Li//LATP//Li cell has an interfacial impedance around 100 kΩ/cm², the Li//UVEA-LATP-UVEA//Li cell has a low impedance on the order of a few hundred Ω/cm², which is 3 orders of magnitude smaller.

FIG. 37C shows that in a Li/LATP//Li symmetric cell, the cell fails upon first charging.

FIG. 37D shows the Ti 2p XPS spectra of (top) pristine LATP powder, (middle) Li⁰ from cycled Li//LATP//Li, and (bottom) Li⁰ from cycled Li//UVEA-LATP-UVEA//Li.

FIG. 37E are digital images of LATP pellets from cycled (left) Li//LATP//Li and (right) Li//UVEA-LATP-UVEA//Li.

FIG. 37F is an SEM image of deposited Li⁰ on Cu foil surface. The SEM image on the right shows that the Li metal deposits are flat and do not have dendritic features.

FIGS. 37G and 37H show cryo-TEM image of deposited Li⁰ on Cu grid (FIG. 37G) and corresponding SAED pattern (FIG. 37H) using the sandwich UVEA-LATP-UVEA electrolyte.

FIG. 37I is an HAADF-STEM image and elemental mappings of deposited Li⁰ surface using the sandwich UVEA-LATP-UVEA electrolyte.

FIG. 37J is a cryo-STEM image of Li⁰ surface.

FIG. 37K is an enlarged image from the selected area of FIG. 37J.

FIGS. 37L and 37M shows F1s and N 1s XPS spectra, respectively, of Li⁰ from cycled Li//UVEA-LATP-UVEA//Li.

FIG. 38 shows an SEM image (top) of the plated lithium against the UVEA-LVO-UVEA sandwich. The cryoEM images (bottom) show the morphology of the plated lithium and the SEI in cryogenic conditions.

FIGS. 39A-39E show the electrochemical performance of sandwich-type SSEs. FIG. 39A shows the critical current density of UVEA-LATP-UVEA tested in symmetric Li//Li cells at 22° C. (RT). The Li/Li symmetric cell was cycled under step-up current densities, and no short circuit occurred before 14 mA cm⁻². The charge/discharge capacity was fixed at 0.5 mAh cm⁻². FIG. 39B shows the discharge/charge profile of solid-state Li//UVEA-LATP-UVEA//Li battery at a current density of 0.5 mA cm⁻² and a cycling capacity of 1 mAh cm⁻². The cell can cycle more than 2500 hours without failing. FIG. 39C shows the cycling stability of Li//UVEA-LATP-UVEA//NMC811 cells at 0.2 C. The areal mass loading of NMC811 is ˜8 mg cm⁻². It can reach a capacity retention of 87% at 250 cycles. FIG. 39D shows the corresponding charge/discharge profiles of Li//UVEA-LATP-UVEA//NMC811 cells at 0.2 C. FIG. 39E shows the cycling performance of sandwich-type SSEs based solid-state cells with high loading NMC811 cathodes under a low N/P ratio of 1.25. The cells were cycled at 0.2 C and 22° C. with 2 mAh cm⁻² of Li⁰ (deposited on Cu foil) as the anode.

FIGS. 40A and 40B shows the cycling performance of Li/LVO//Li and Li//PolyEA-LVO-PolyEA//Li, respectively.

FIG. 41 shows the measured Coulombic Efficiency as a function of FEC content in SPE. At 0.1 wt % or below, the Coulombic efficiency is too low to be measured. When the FEC amount increased to 5 wt %, the CE of the Li—Cu cell reached 99.0%. Above 10 wt % FEC, the CE plateaus at around 97.5%.

### DETAILED DESCRIPTION OF THE INVENTION

Referring now to the figures, the present invention features a solid state battery comprising an anode, a cathode, and a solid polymer electrolyte (SPE). In some embodiments, the battery can be a lithium-ion battery or a lithium-metal-anode battery. In other embodiments, the anode may comprise Li metal, graphite, silicon, Li₄Ti₅O₁₂ or combinations thereof. In some other embodiments, the cathode may comprise LiFePO₄, LiCoO₂, LiNiₓMn_{y}Co_{1-x-y}O₂ (NMC) with x ranging from 0.33 to 1 and y ranging from 0 to 0.4, layered oxide cathodes, Li—Mn-rich cathodes, conversion cathodes, or derivatives thereof.

In some preferred embodiments, the SPE comprises a polymerized product of a polymer backbone comprising poly(ethylacrylate) or polyacrylonitrile, and a salt ionizing and Li conducting plasticizer comprising succinonitrile. In other embodiments, the SPE may further comprise an electrolyte additive. Non-limiting examples of the electrolyte additive include fluoroethylene carbonate (FEC), vinylene carbonate, or a combination of FEC and vinylene carbonate. In some other embodiments, the SPE may further comprise a Li salt. In a non-limiting embodiment, the Li salt is LiTFSI.

In conjunction with any of the embodiments described herein, the amount of the electrolyte additive may range from about 1 wt % to about 50 wt %. In some preferred embodiments, the amount of the electrolyte additive may range from about 1 wt % to about 5 wt %. In other embodiments, the amount of the electrolyte additive may range from about 5 wt % to about 25 wt %. In yet embodiments, the amount of the electrolyte additive may range from about 20 wt % to about 50 wt %.

In one non-limiting embodiment, the SPE can have a storage moduli in a range of about 200 MPa-300 MPa. In another non-limiting embodiment, the SPE can have a loss modulus in a range of about 20 MPa-60 MPa. In some embodiments, a thickness of the SPE is in the range of about 5 μm-400 μm. In some embodiments, the thickness of the SPE ranges from about 5 μm-100 μm, or about 100 μm-200 μm, or about 200 μm-300 μm, or about 300 μm-400 μm.

In some embodiments, a Coulombic efficiency of the battery is at least 95%. In other embodiments, the Coulombic efficiency of the battery is about 97%. In some embodiments, the Coulombic efficiency of the battery is at least 98%. In other embodiments, the Coulombic efficiency of the battery is about 99%.

According to some embodiments, the present invention features a method of synthesizing a solid polymer electrolyte (SPE) for a solid state battery. The method may comprise providing a prepolymer mixture comprising i) a polymer precursor comprising ethylacrylate or acrylonitrile monomers, and ii) a plasticizer comprising succinonitrile, and polymerizing said prepolymer mixture to produce the SPE. In some embodiments, the step of polymerizing may comprise heating or photopolymerizing said prepolymer mixture.

In some embodiments, the prepolymer mixture may further comprise an electrolyte additive. Examples of the electrolyte additive include, but are not limited to, fluoroethylene carbonate (FEC), vinylene carbonate, or a combination of FEC and vinylene carbonate. In other embodiments, the prepolymer mixture may further comprise a Li salt. In a non-limiting embodiment, the Li salt is LiTFSI. In some other embodiments, the prepolymer mixture may further comprise a crosslinker. A non-limiting example of the crosslinker is ethylene glycol dimethylacrylate.

According to other embodiments, the present invention features a solid-electrolyte interphase (SEI) film. The SEI film may comprise a polymerized product of a polymer backbone comprising poly(ethylacrylate) or polyacrylonitrile, and a salt ionizing and Li conducting plasticizer for a solid state battery comprising succinonitrile. In some embodiments, the SEI film may further comprise an electrolyte additive. Examples of the electrolyte additive include, but are not limited to, fluoroethylene carbonate (FEC), vinylene carbonate, or a combination of FEC and vinylene carbonate. In other embodiments, the SEI film may further comprise a Li salt, such as, for example, LiTFSI.

In some embodiments, the film may be disposed on a surface of an anode. For example, the anode may be plated with a solid-electrolyte interphase (SEI) film. Non-limiting examples of the anode include Li metal, graphite, silicon, Li₄Ti₅O₁₂ or combinations thereof. In some embodiments, the thickness of the SEI film ranges from about 1-30 nm.

According to some embodiments, the present invention features an anode for a solid state battery. In some preferred embodiments, the anode is plated with any of the solid-electrolyte interphase (SEI) film described herein. According to other embodiments, the present invention features a method of producing an anode for a solid state battery. The method may comprise providing an anode material, and plating said anode material plated with any of the solid-electrolyte interphase (SEI) film described herein. In some embodiments, the thickness of the SEI film ranges from about 1-30 nm. In some embodiments, the anode is comprised of Li metal, graphite, silicon, Li₄Ti₅O₁₂ or combinations thereof.

According to another embodiment, the present invention features a solid electrolyte separator for a solid state battery. In one embodiment, the solid state battery may comprise an anode, a cathode, and the solid electrolyte separator. In some embodiments, the anode may comprise Li metal, graphite, silicon, Li₄Ti₅O₁₂ or combinations thereof. In other embodiments, the cathode may comprise Li⁰, LiFePO₄, LiCoO₂, LiNiₓMn_{y}CO_{1-x-y}O₂ (NMC) with x ranging from 0.33 to 1 and y ranging from 0 to 0.4, layered oxide cathodes, Li—Mn-rich cathodes, conversion cathodes, or derivatives thereof. In yet other embodiments, the cathode may comprise NMC-622 or NMC-811.

In some preferred embodiments, the separator may comprise a ceramic layer sandwiched between two polymer layers. The polymer layers may comprise a polymerized product of a polymer backbone comprising poly(ethylacrylate) or polyacrylonitrile, and a salt ionizing and Li conducting plasticizer comprising succinonitrile. In some embodiments, the polymer layers further comprise an electrolyte additive. Non-limiting examples of the electrolyte additive include fluoroethylene carbonate (FEC), vinylene carbonate, or a combination of FEC and vinylene carbonate. In other embodiments, the polymer layers may further comprise a Li salt, such as, for example, LiTFSI. In preferred embodiments, the polymer layers are electron-insulative.

According to some embodiments, the present invention features a method of synthesizing a solid electrolyte separator for a solid state battery. The method may comprise providing a prepolymer mixture comprising i) a polymer precursor comprising ethylacrylate or acrylonitrile monomers, ii) a crosslinker, and iii) a plasticizer comprising succinonitrile; polymerizing said prepolymer mixture to produce a polymer film; stacking a ceramic layer between two layers of the polymer film to form a stack; and applying a pressure onto the stack, thereby forming the solid electrolyte separator. Without wishing to limit the present invention, in some preferred embodiments, a pressure of less than 8 MPa is applied onto the stack. In other embodiments, the step of polymerizing the prepolymer mixture may comprise heating or photopolymerizing said mixture.

In some embodiments, the prepolymer mixture may further comprise an electrolyte additive. Examples of the electrolyte additive include, but are not limited to, fluoroethylene carbonate (FEC), vinylene carbonate, or a combination of FEC and vinylene carbonate. In other embodiments, the prepolymer mixture may further comprise a Li salt such as, for example, LiTFSI. In yet other embodiments, the prepolymer mixture may further comprise a crosslinker. A non-limiting example of the crosslinker is ethylene glycol dimethylacrylate. In preferred embodiments, the polymer film layers are electron-insulative.

In conjunction with any of the embodiments described herein, the ceramic layer has Li ion conductivity. In some embodiments, the ceramic layer may comprise any solid lithium ion conducting materials or solid mixed ionic electronic conductors. In some embodiments, the ceramic layer may comprise Li₁₊ₐAlₐTi₂₋ₐ(PO₄)₃ (LATP) with 0≤a≤0.7, Li_{1+b}Al_{b}Ge_{2-b}(PO₄)₃ with 0≤b≤1.5, LiV₃O₈ (LVO), Li₇La₃Zr₂O₁₂ (LLZO), Li_{7-c}La₃Zr_{2-c}Ta_{c}O₁₂ (LLZTO) with 0≤c≤2, LiOH, lithium nitride, lithium titanium oxide, lithium iron phosphate, Li₁₀GeP₂S₁₂ (LGPS), Li₇P₃S₁₁ (LPS), Li₅PS₅Cl, or derivatives or combinations thereof.

According to some embodiments, the present invention features a polymer electrolyte composition comprising monomers comprising ethylene acrylate or acrylonitrile, and a salt ionizing and Li conducting plasticizer comprising succinonitrile. In some embodiments, the composition may further comprise an electrolyte additive. In some embodiments, the electrolyte additive comprises fluoroethylene carbonate (FEC) or a combination of FEC and vinylene carbonate. The amount of the electrolyte additive can range from about 1 wt % to about 50 wt %. In other embodiments, the composition may further comprise a Li salt. In some embodiments, the Li salt is LiTFSI. In some embodiments, the composition may further comprise a crosslinker. In a non-limiting embodiment, the crosslinker may comprise ethylene glycol dimethylacrylate. In some other embodiments, the composition may further comprise an initiator. In a non-limiting embodiment, the initiator may comprise azobisisobutyronitrile

As used herein, UVEA may be used interchangeably with polyEA. However, one of ordinary skill in the art would understand that UVEA is polyEA made with photosynthesis. It is a subclass of polyEA.

EXAMPLE 1—The following is a non-limiting example of the present invention. It is to be understood that said example is not intended to limit the present invention in any way. Equivalents or substitutes are within the scope of the present invention.

### Methods

### Synthesis of FEC-SPE and SN-SPE.

The SPEs were synthesized via a solvent-free, single-step, and thermal-triggered free radical polymerization. Typically, ethylene acrylate monomer (0.15 g, Sigma Aldrich), ethylene glycol dimethylacrylate crosslinker (0.15 g, Sigma Aldrich), lithium bis(trifluoromethanesulfonyl)imide (0.3 g, Sigma Aldrich), succinonitrile solid crystal plasticizer (0.5 g, TCI), azobisisobutyronitrile initiator (0.005 g, Sigma Aldrich) were premixed to form a homogeneous precursor solution. The above solution was cast onto a glass fiber support and then sandwiched between two pieces of stainless steel. After heating at 65° C. for 24 hours to initiate the polymerization, the resulting SPE was peeled off from the stainless steel and stored in an argon-filled glove box before use. For FEC-SPE, 5 wt % of 4-fluoro-1,3-dioxolan-2-one (FEC) was introduced as the additive. The thickness of SN-SPE and FEC-SPE are both in the range of 300-400 μm. Note that ethylene glycol dimethylacrylate was employed as a crosslinker to improve the mechanical properties of prepared SPE. During the fabrication of SPE, no organic solvent was applied, the mixing of SN, LiTFSI, monomer, and crosslinker can lead to a well flowable liquid precursor for subsequent SPE fabrication process.

### Assemble of In-Situ Optical Cell

The in-situ optical cell was assembled with a polytetrafluoroethylene cell covered with a transparent quartz window. Li⁰ foil was employed as both the reference and working electrode. The distance between two electrodes was 2.5 mm. The polymer precursor containing monomer, crosslinker, plasticizer, lithium salt and photoinitiator (phenylbis(2,4,6-trimethylbenzoyl) phosphineoxide, 0.5 wt %) was injected to the cell and then subjected to UV irradiation for 15 mins to initiate the polymerization. The cell was charged at a fixed current density of 1 mA/cm², and a digital camera was used to monitor the lithium plating process in the optical cell. Note that during UV polymerization, the monomers could be polymerized within 10 mins (20 hours for thermal polymerization), thus the possible side reactions between lithium metal and monomers could be minimized.

### Electrochemical Tests

The electrochemical performance was tested in 2032 type coin cells assembled in an Argon filled glove box with water content <1 ppm and oxygen content <1 ppm. Electrochemical impedance spectroscopy (EIS) was recorded on a Bio-logic SAS at a frequency range from 1 MHz to 1 Hz. The ionic conductivities (01, S/cm) of SPEs were calculated according to equation (1),

$${σ}_{t} = d / ( {R}_{t} \cdot S ) \qquad ( 1 )$$

where d (cm), S (cm²), and Rₜ (ohm) are the measured thickness, area, and resistance of the SPE.

The transference number was determined by the potentialstatic method and calculated according to equation (2),

$${t}_{+} = \frac{{I}_{ss} ( Δ V - {I}_{0} {R}_{0} )}{{I}_{0} ( Δ V - {I}_{S S} {R}_{SS} )} \qquad ( 2 )$$

where, ΔV is the applied polarization voltage (10 mV). I₀ and Iₛₛ are the initial and steady-state currents, respectively. R₀ and R_{SS} are the initial and steady-state charge transfer resistance.

The electrochemical stability window was measured by the cyclic voltammetry at a scanning rate of 1 mV/s with lithium metal as the reference electrode and stainless steel as the blocking electrode. The LiFePO₄ (0.3 mAh/cm²) and LiCoO₂ (0.7 mAh/cm²) cathodes were prepared by casting the slurry of active material (80 mg), Super P (10 mg), PVDF binder (10 mg) in NMP onto an Al foil followed by vacuum drying at 80° C. for 12 hours. The obtained electrodes were cut into 12 mm discs and stored in a glove box before use. Commercial high mass loading LiFePO₄ (2 mAh/cm²) and LiNi_{0.8}Mn_{0.1}Co_{0.1}O₂ (NMC811) (2.3 mAh/cm²) cathodes were purchased from MTI and vacuum dried at 80° C. before use. The cathodes discs were soaked in SN/LiTFSI mixture to introduce the ion conduction pathway. Solid-state full cells were assembled with pristine Li⁰ anodes, the as-prepared SPE, and LiFePO₄/LiCoO₂/NMC811 cathodes. The batteries were cycled with a NEWARE multichannel cycler. The cut-off voltages are 2.5-3.8 V for Li—LiFePO₄ cells, and 2.5-4.3 V for Li—LiCoO₂ and Li-NMC811 cells.

### Optimization of FEC Content

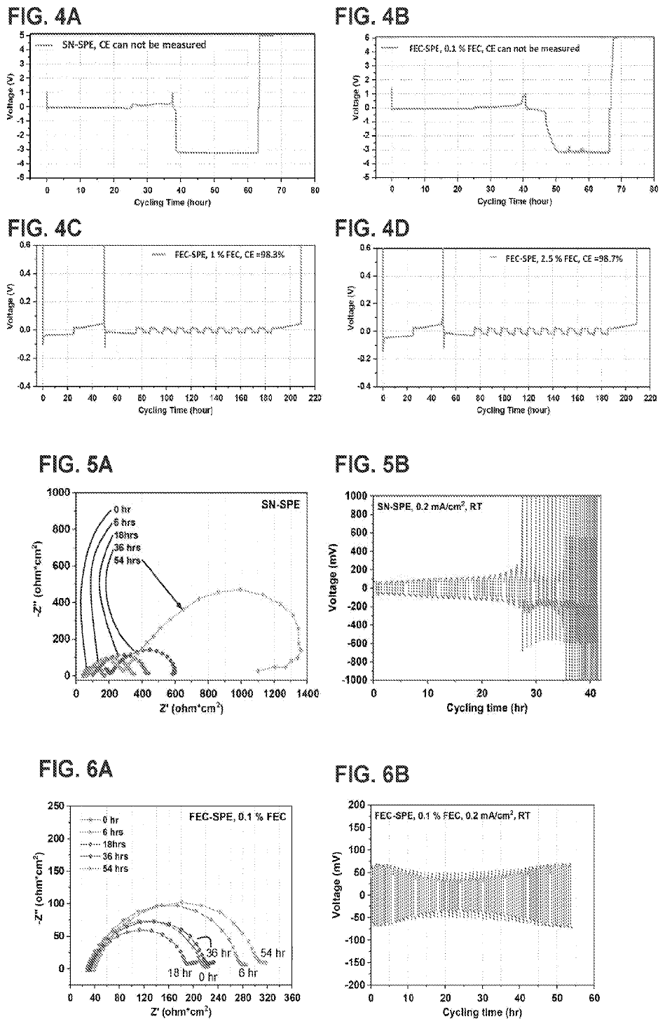

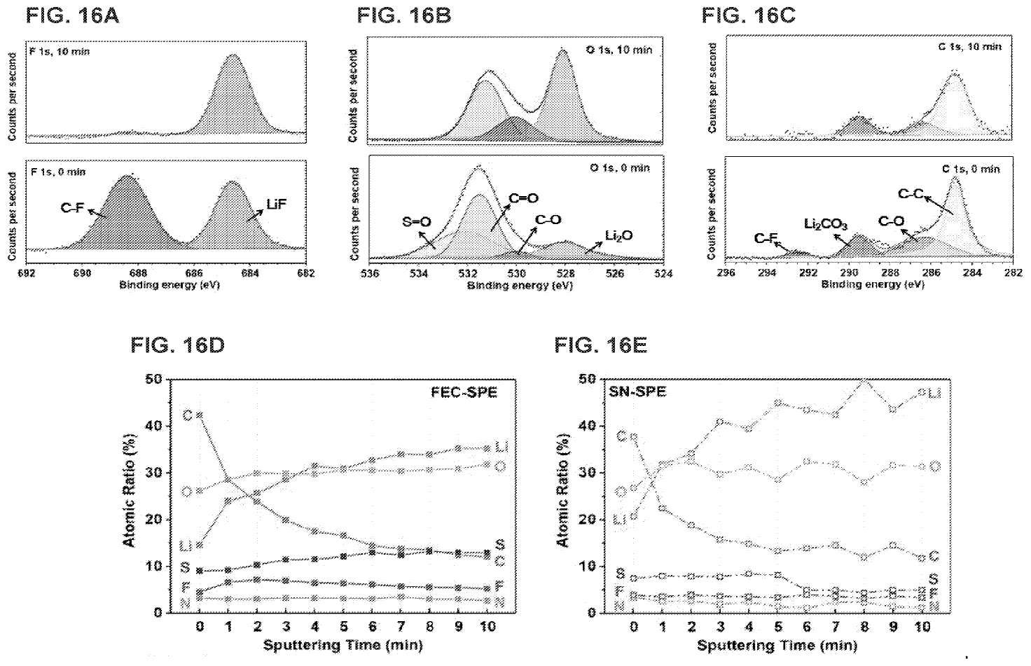

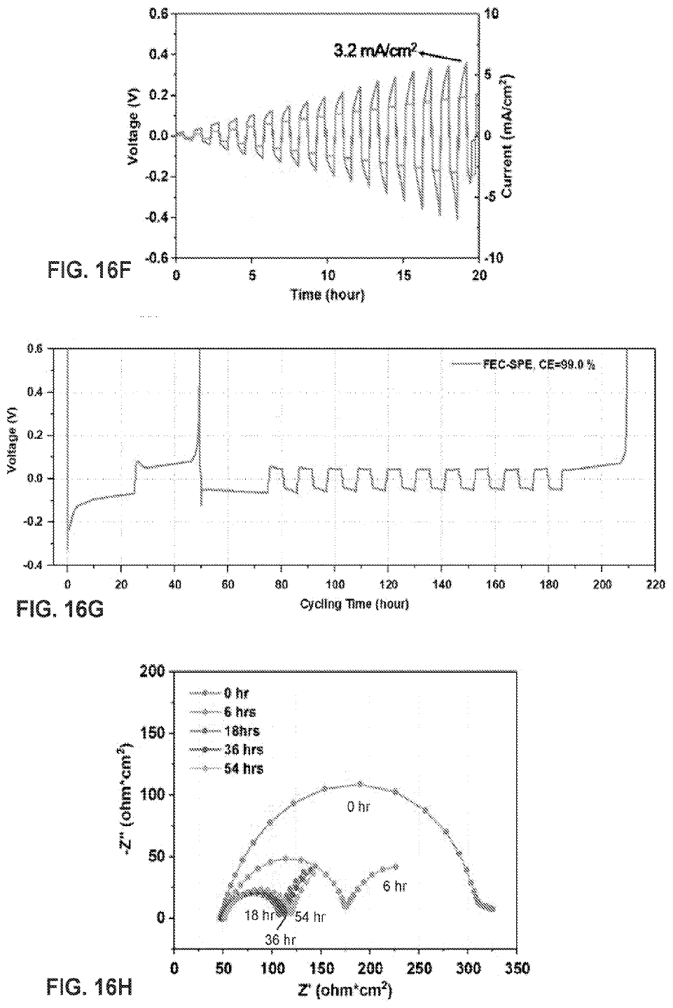

A series of SPEs with different FEC amounts of 0 wt %, 0.1 wt %, 1 wt %, 2.5 wt %, and 5 wt % were prepared with the above-described thermal polymerization method. Li—Cu cells were firstly assembled and their Coulombic efficiencies are measured and shown in FIGS. 4A-4D. For the cells employing SN-SPE (0 wt %) and FEC-SPE-0.1 wt %, the overpotential quickly increased to 3V due to the uncontrolled side reactions, thus the CE could not be determined. With increasing FEC amount, the CE increased to 98.3% (1 wt % FEC) and 98.7% (2.5 wt % FEC), suggesting the critical role of FEC for SEI formation to suppress the dendrite formation and reduce the side reaction. When the FEC amount increased to 5 wt %, the CE of the Li—Cu cell reached 99.0% (FIG. 16G).

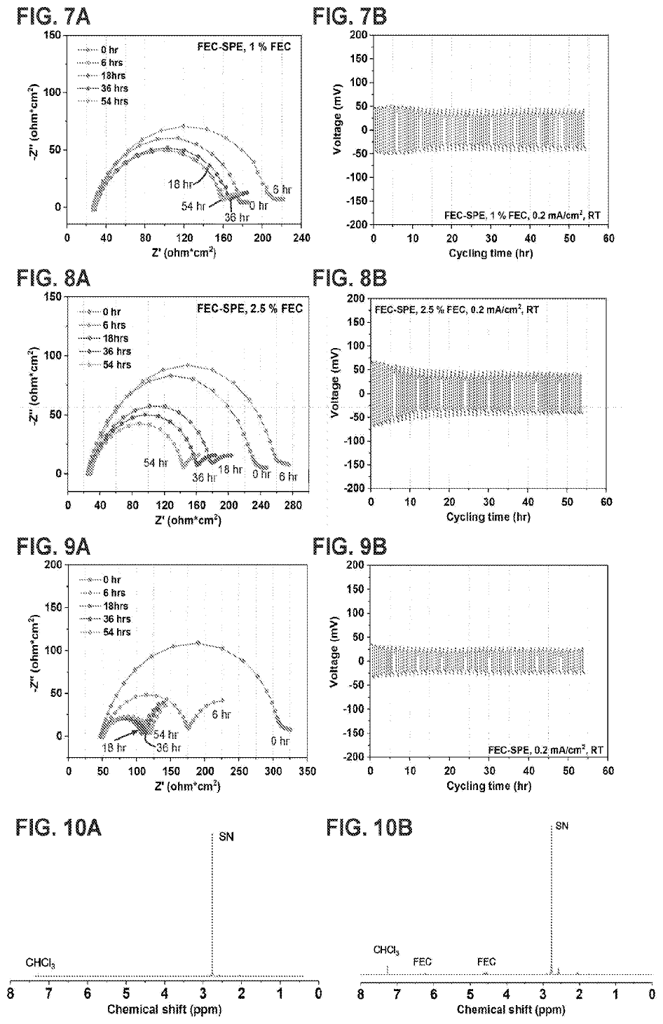

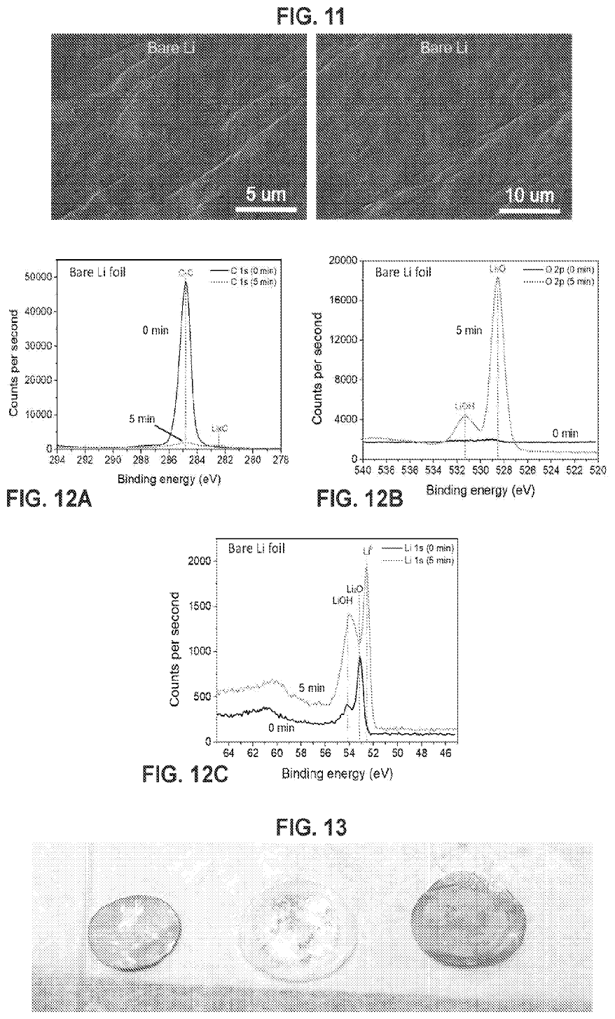

Li—Li symmetric cells were further assembled to study the effect of FEC amount on the interfacial resistance. As shown in FIG. 5A-5B, the SN-SPE (0 wt % FEC) based cell showed increasing interfacial resistance with cycling time. After 54 hrs, the interfacial resistance reached 1000 ohm×cm2, and the cell showed high overpotential >1 V. The addition of 0.1 wt % FEC obviously reduced the interface resistance to 300 ohm×cm2 and the overpotential to 60 mV, but the continuously increasing interfacial resistance suggests that a stable SEI could not be generated. When the FEC content increased to 1 wt % and 2.5 wt %, stable and lower interfacial resistance of 130 ohm×cm2 and 100 ohm×cm2 could be observed, respectively (FIGS. 6A-6B, 7A-7B, 8A-8B, and 9A-9B). The symmetric cells showed stable overpotential ˜50 mV. Finally, at the optimized FEC content of 5 wt %, a constant interfacial resistance of 70 ohm×cm2 and low overpotential of ˜30 mV could be achieved.

### Monomer Conversion Yield Determination

To exclude the possible side reaction between the remaining monomer/oligomer and lithium metal, the monomer conversion yield was measured by the liquid-state 1H NMR technique. The prepared SPEs were soaked in CDCl₃ for 24 hr and the obtained solution was subjected to NMR characterization. Since the polymer backbone is crosslinked and non-soluble, only the signal of un-polymerized monomer or oligomer (if any), SN plasticizer, and FEC additive could be observed in the NMR spectra. FIG. 10A showed the NMR of SN-SPE. Only the signal of SN plasticizer could be observed and the absence of monomer/oligomer signals suggests a close to quantitative monomer conversion yield. FIG. 10B showed the NMR spectrum of FEC-SPE. Both the signals of SN plasticizer and FEC additive could be observed, while the signal for monomers could not be detected. In addition, based on the integral area of FEC signals and SN signals, the molar ratio between SN and FEC was calculated to be 14.8:1, which is close to the theoretical value (13.3:1). The thermal polymerization route can ensure almost quantitative monomer conversion yield and the possible safety hazard due to unreacted monomer or oligomer could be eliminated.

### Material Characterization.

The cycled Li—Cu or Li—Li cells were disassembled (FIG. 13) and the SPE, lithium metal, and Cu foil electrode were separated for interfacial characterization. The cryoEM experiments were performed by using a Gatan single-tilt liquid nitrogen holder designed for the frost-free transfer of a sample at the liquid nitrogen temperature in an FEI Talos F200X transmission electron microscope operated at 200 kV with an X-FEG field emission source and Super-X EDS detectors. To prepare the TEM samples for cryoEM, the coin cells were assembled by putting a TEM copper grid on a Cu foil as the working electrode in a glove box in an argon atmosphere. After deposition, the cell was disassembled in the glove box and then the copper grid was sealed inside a bag. Next, the sealed TEM sample was plunged into a bath of liquid nitrogen, quickly loaded onto the precooled cryo holder, and finally transferred into the TEM.

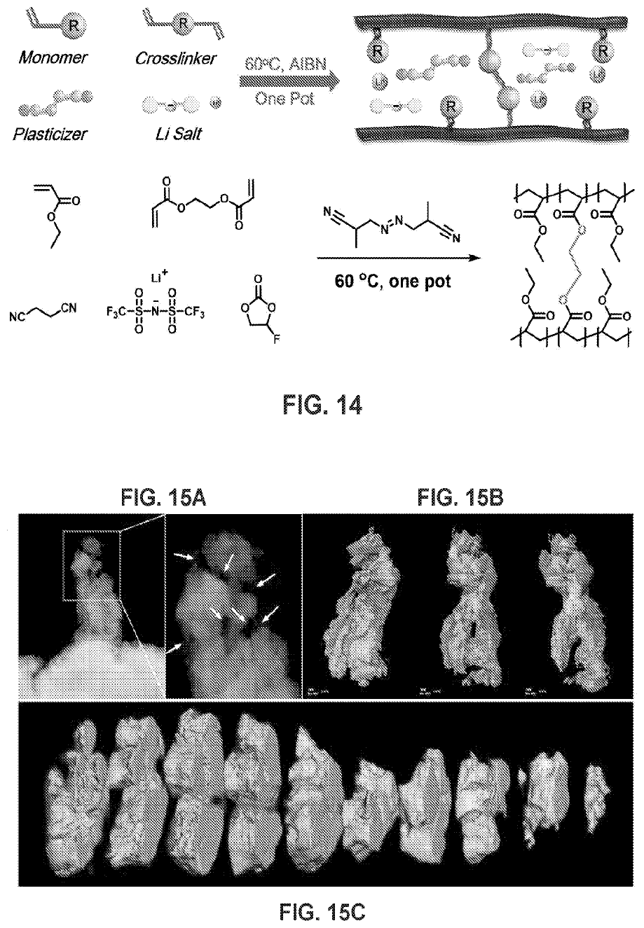

The SPE was synthesized via a one-pot thermal polymerization route (FIG. 14). The polymer precursor containing ethylene acrylate (EA) monomer, ethylene glycol dimethylacrylate crosslinker, SN plasticizer, LiTFSI salt, and a thermal initiator was heated at 60° C. to yield the SPE without further treatment. The interface instabilities of SN-incorporated SPE (denoted as SN-SPE) were firstly revealed by cryogenic transmission electron microscopy (cryoEM) studies. In the past few years, cryoEM has become a vital tool for the direct imaging of the SEIs and lithium plating morphologies because of its capability to increase the critical dose of radiation-sensitive materials and thus the resolution and protect Li⁰ from reacting with air. Using the cryoEM technique, the inventor found that no well-defined interphase film can be formed and large amounts of LiₓNC was generated as decomposition products, indicating a sustained spontaneous reaction between Li⁰ and SN plasticizer as well as with the polyacrylate (PolyEA) polymer backbones. The introduction of fluoroethylene carbonate (FEC) as an additive successfully eliminates the corrosive side reaction and promotes the formation of a robust interphase, which is revealed by cryoEM as a compact 20-30 nm thick layer with a mosaic structure. X-ray photoelectron spectroscopy (XPS) analysis also revealed increased F, S, N content, and O/C ratio in the interphase. It indicates that the FEC additive, the PolyEA backbone, and TFSI anion all participated in the interphase formation. Much improved CE in FEC-presence suggests that the uncontrolled decomposition of SN plasticizer has been effectively suppressed. In-situ optical microscopy and ex-situ SEM observations all revealed a dense and uniform morphology of the deposited lithium, which is in sharp contrast to the porous and dendritic morphology for baseline SN-SPE without FEC. Benefited from the cryoEM study, a stable LiF-rich interphasial chemistry was obtained using FEC additive and the solid-state batteries were able to cycle at a high limiting current density of 3.2 mA/cm² with excellent lithium plating/stripping CE of 99%. The highly stable SEI enables a low charge transfer resistance of 70 ohm×cm², allowing stable cycling at 1 mAh/cm² for 1800 hours. Also attributed to the high-voltage electrochemical stability of the SN plasticizer, the Li∥LCoO₂ full cell retains 90% of its initial capacity after 400 cycles and the Li∥LFP full cell showed excellent cycle life longer than 1800 cycles.

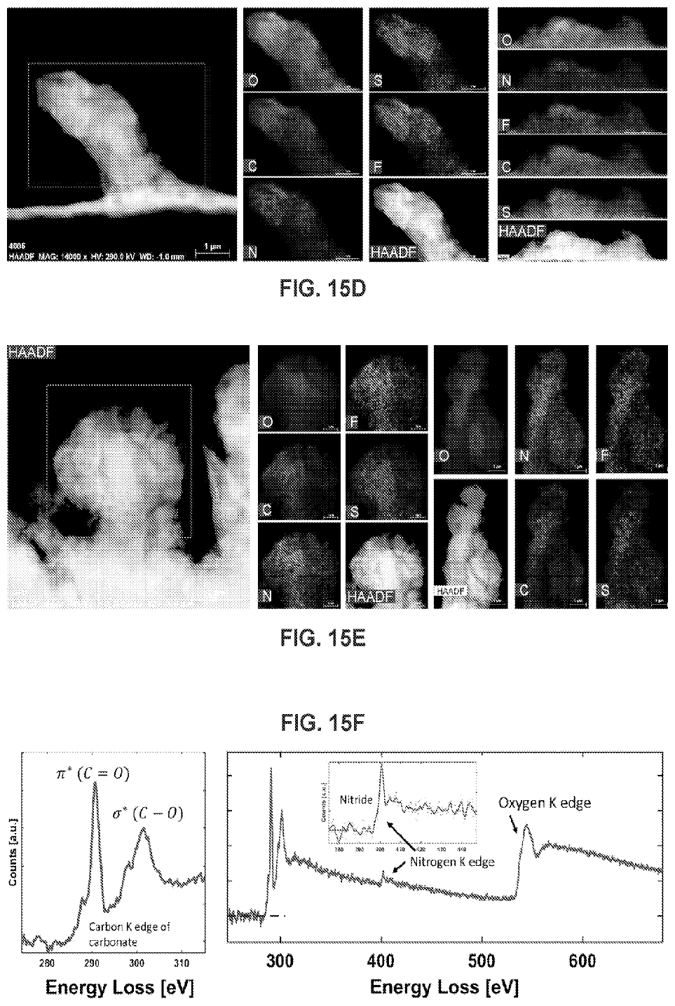

FIGS. 15A-15E show the cryogenic scanning transmission electron microscopy (cryoSTEM) imaging of morphology and chemistry of lithium that are plated using baseline SN-incorporated PolyEA SPE (SN-SPE) with a current of 0.1 mA for 60 minutes. FIGS. 15A-15C show representative high angle annular dark-field STEM (HAADF-STEM) images of several Li filaments from different regions. Interestingly, these cryoSTEM results show that the filaments are morphologically different from those filaments previously reported for liquid electrolyte systems. Lithium filaments grown in liquid electrolytes appear to be dense Li⁰ dendrites coated with SEI films. In HAADF-STEM or Z-contrast imaging mode, these dendrites usually have darker contrast in the interior of the dendrite (corresponding to Li⁰) than that in the SEI, because Li⁰ has much lower scattering than the SEI which contains species, such as C and O, with higher atomic numbers. However, in the baseline SN-SPE, the Li filaments show bright contrast in most regions, while only small amounts of dark domains or stripes are observed (as marked with arrows in FIG. 15A). It suggests side reactions had taken place and cracks or voids had formed in the filaments. Additionally, no conformal SEI films are observed on the filaments.

To investigate the three-dimensional (3D) internal structure of the filaments, cryoSTEM tomography was performed. The 3D reconstruction (FIG. 15B) and cross-section analyses (FIG. 15C) of a representative filament show that multiple cracks formed throughout the filament, which is likely attributed to the large stress induced by volume change during the side reactions with the SN-SPE. Energy-dispersive X-ray spectroscopy (EDS) maps of several filaments (FIGS. 15D and 15E) and electron energy-loss spectroscopy (EELS) results (FIG. 15F) show that, regardless of their morphology and size, all examined filaments contain large amounts of oxygen, carbon, sulfur, fluorine, and nitrogen. Chemical analyses in conjunction with the 3D tomography results indicate that the irregular morphology of the filament is the result of undesired side reactions of the as-grown Li⁰ with the SN plasticizer and the PolyEA backbone (because the Li⁰ can penetrate the SPE). It is worth noting that as the O, C, N, S, and F are distributed throughout the whole filament in all locations, it demonstrates that, for the SN-SPE system, the side-reaction product cannot form passivating SEI to protect the Li⁰ surface. This is to some extent surprising because it shows that the Li⁰ surface cannot be passivated in succinonitrile containing SPE. The cracks formed in the lithium filaments suggest a stress corrosion behavior and indicate the failure of the Li⁰ anode is due to unpassivated corrosion (referring to continuous side reactions). In addition, this result also explains the poor reversibility of Li∥SN-SPE∥Cu cells.

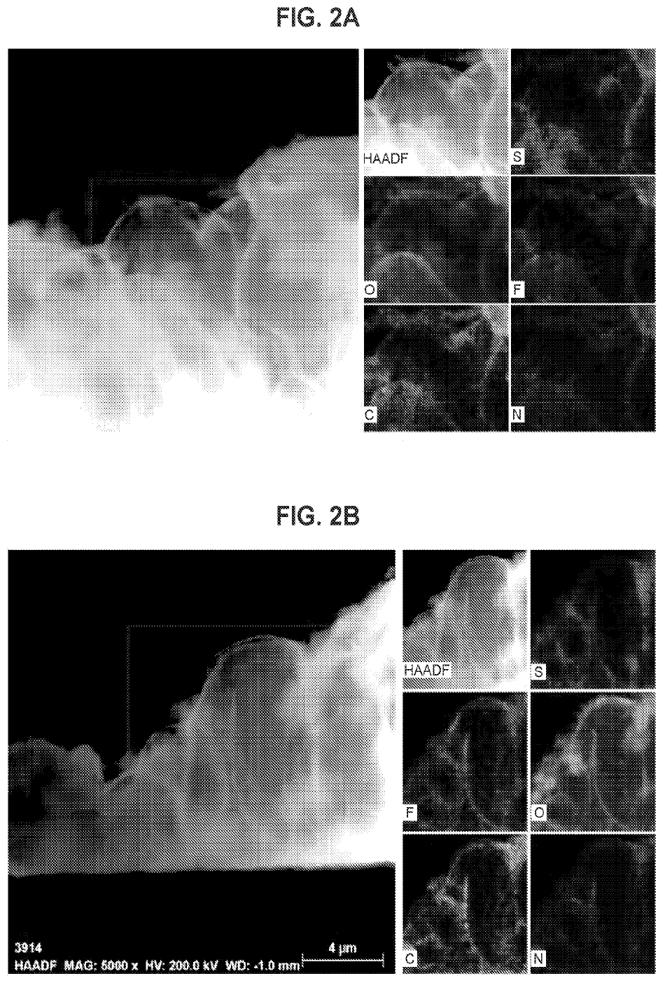

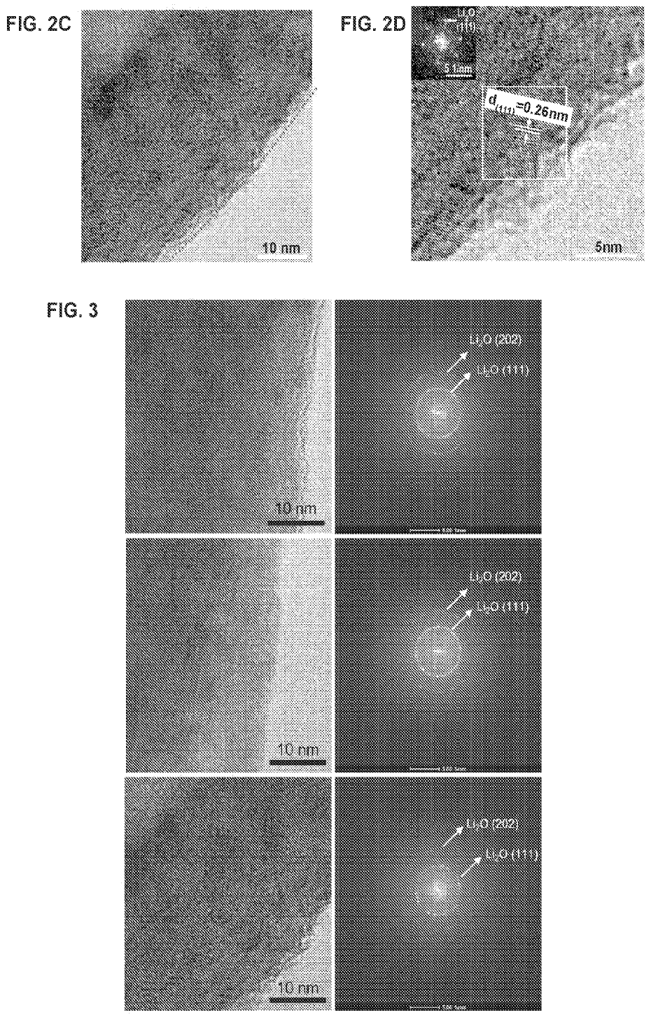

One advantage of polymer electrolytes is that the additives can be easily added to the electrolyte uniformly without changing the physical and conductive properties of the baseline polymer electrolytes. Therefore, to mitigate the detrimental corrosive side-reaction of Li⁰ with the SN plasticizer and the polymer backbone, 5 wt % of FEC was introduced to the SPE intending to form passivating SEI to protect Li⁰ against undesired side reactions with SN and PolyEA (denoted as FEC-SPE). FIGS. 2A and 2B show representative ADF-STEM images and chemical analyses of the Li⁰ deposits plated using the FEC-SPE. In contrast to the side-reacted Li-containing filaments, deposits in the SN-SPE system are shown in FIGS. 15A-15E. The deposits in FEC-SPE are primarily Li⁰ with a thin, conformal SEI coating. The deposits have a well-defined dome shape (a few micrometers in diameter) and are densely packed together. The appearance of dense packing and the lack of dendrite-shaped filaments suggest that these Li⁰ deposits were plated in a planar manner which is highly desired.

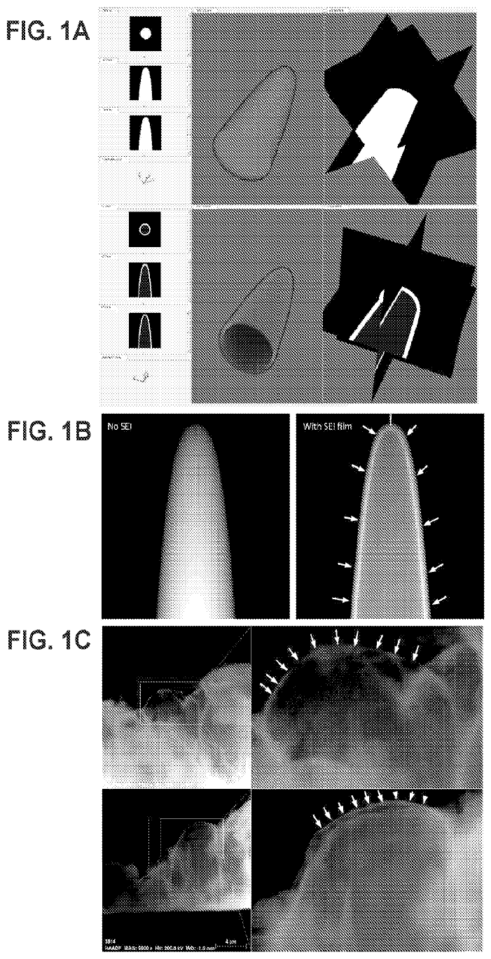

In FIGS. 1A and 1B, the darker contrast inside the dome indicates that the Li⁰ remains intact. Conformal SEI films (surface regions with brighter contrast) with a thickness of dozens of nanometers formed on the surface of the Li⁰ domes. EDS maps confirmed the formation of SEI films because O, C, N, S, and F are only enriched on the surface, but not inside of the domes. The dense and uniform SEI film formation facilitated by additive engineering plays a vital role in mitigating the side reactions and cracking of Li⁰ deposits, a chemo-mechanical breakdown of the interphase/interface.

FIG. 2C presents a representative atomic-resolution cryoEM image of the SEI film which shows its mosaic structure. It is composed of nano-sized crystalline domains with random crystallographic orientation embedded in a film. FIG. 2D highlights a zoom-in image and corresponding fast Fourier transform (FFT) of a Li₂O nanocrystal (the (111) plane with a lattice spacing of 0.26 nm is denoted in the boxed region) inside the SEI. In addition, because EDS maps show fluorine is distributed throughout the SEI film, it was expected to observe LiF crystals in the SEI film. Surprisingly, contrary to said expectation, there was a lack of LiF Bragg diffractive spots/rings in the diffractograms; only Bragg diffractive rings of Li₂O were observed in the diffractograms of high-resolution cryoEM images from multiple locations on different lithium filaments (FIG. 3). This suggests the LiF-rich phase is not present in a nano-crystalline form, but it is rather disordered or even amorphous in the SEI film. It was unexpected and also demonstrated that SEI films with a disordered/amorphous LiF-rich phase can passivate Li⁰ anode. Without wishing to be bound to a particular theory or mechanism, FEC promotes the formation of a LiF-rich SEI that improves Li⁰ anode's plating morphology, CE, and reversibility.

XPS further revealed the enrichment of inorganic components in FEC-SPE-derived SEI. The F1s profile in FIG. 16A shows a distinct LiF peak at 684.8 eV. The LiF as the electrochemical reduction product of FEC has been reported to contribute to a compact and stable SEI. In addition, both O1s and C1s spectra revealed the existence of Li₂O and Li₂CO₃ as the SEI components (FIGS. 16B and 16C), which were mainly ascribed to the reduction of PolyEA backbones. FIGS. 16D and 16E show the atomic ratio in SEI obtained from XPS quantitative analysis. The SEI from the FEC-SPE system exhibits a higher F and S content than SN-SPE further suggesting the participation of TFSI anion in the SEI formation to improve the inorganic content and robustness of SEI. The reduction of both FEC and LiTFSI leads to the higher F content of FEC-SPE derived SEI. The increase of F and S content, and the decrease of C content with sputtering time suggest that organic components are richer on the top surface of SEI while inorganic components are richer at the bottom of the SEI.

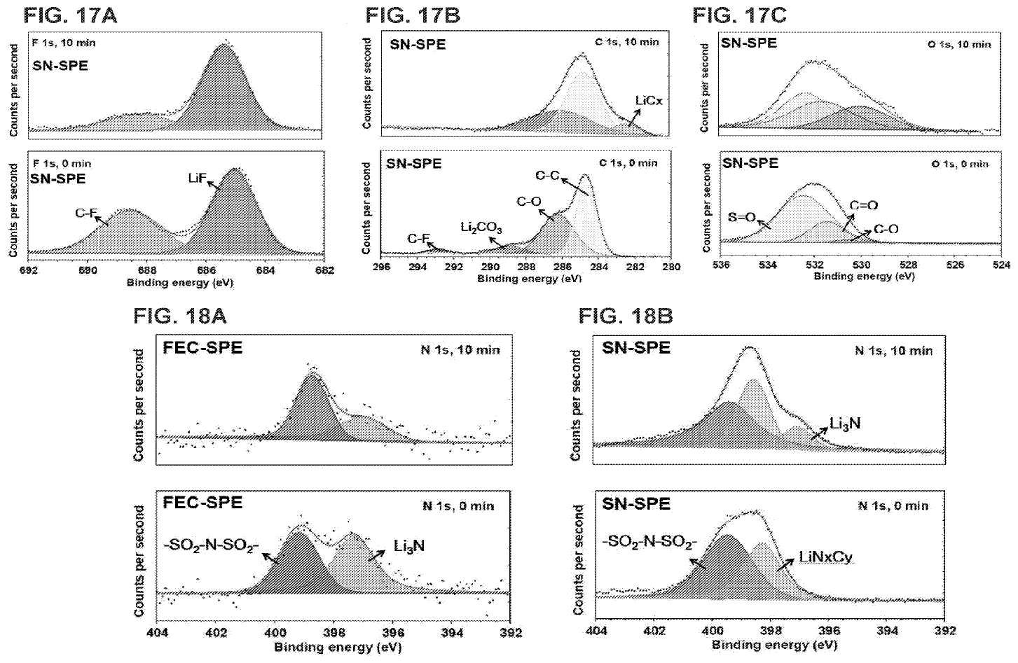

The XPS profiles of SN-SPE derived SEI were provided in FIGS. 17A-17C. LiF was also observed due to the decomposition of LiTFSI. Inorganic Li₂CO₃ and Li₂O were not identified as the SEI component. The C—C, C—O, and C═O signals in C 1s and O 1s profiles suggest the SEI contains high content of organic species which possibly result from the degradation of SN and polymer backbone. With increasing sputtering time, the LixC signal appearing at 282.4 eV (28) could be assigned to the final reduction product of the above-mentioned organic species. The N1s profiles of SN-SPE and FEC-SPE were shown in FIGS. 18A and 18B. Signals for LiTFSI fragments could be observed at 399.4 eV for both SN-SPE and FEC-SPE. FEC-SPE derived SEI showed Li₃N signal at 397.1 eV, which is due to the reduction of LiTFSI, while SN-SPE showed signal at 398.5 eV due to the decomposition of SN.

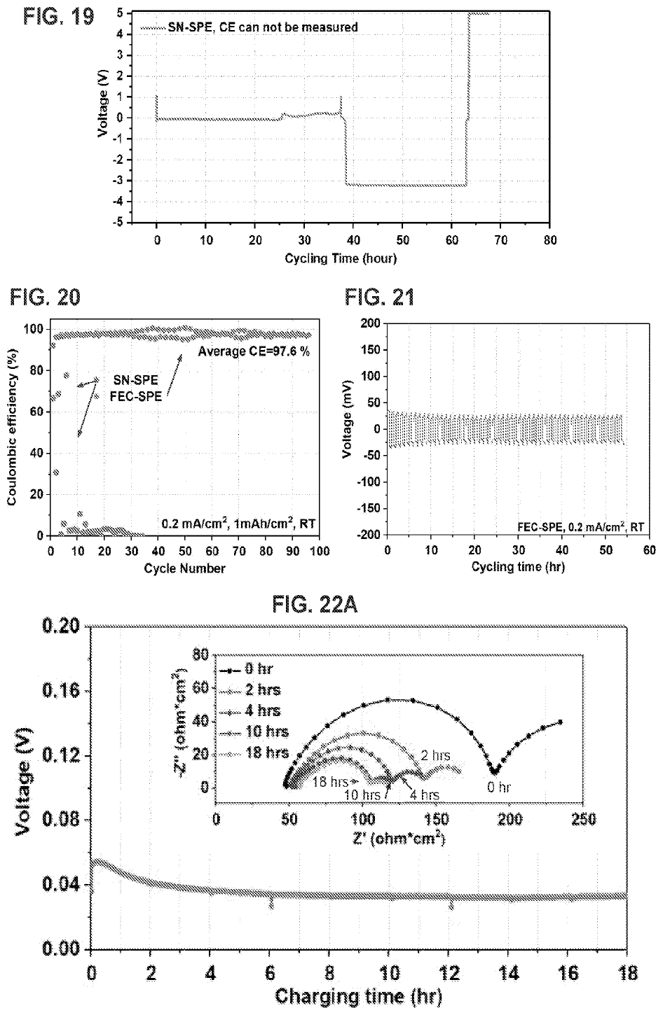

A benefit of this engineered SEI in preventing dendrite formation was proven by a high critical current density (CCD) of 3.2 mA/cm² as shown in FIG. 16F. This current density is sufficient to meet the demand of 1 C charge/discharge rate for commercial cells with a high areal capacity of 3 mAh/cm². Note that these values were achieved with pristine lithium foils without adopting any interfacial layer or advanced electrode architecture. The reversibility of the lithium stripping/plating process was another bottleneck for solid-state electrolytes, due to the electrolyte degradation, electrode volume change, and dead lithium formation. In this study, the Li∥FEC-SPE∥Cu cell showed an impressive CE of 99% at r.t. (FIG. 16G), suggesting minimized SPE degradation and dead Li formation enabled by the engineered SEI. In contrast, the Li∥SN-SPE∥Cu cell quickly failed with a voltage spike (FIG. 19). The CE was further measured under the common protocol at a fixed capacity of 1 mAh/cm² and a cutoff voltage of 1.0 V. In FIG. 20, the Li—Cu cell with SN-SPE showed poor CE below 80% and quickly failed after a few cycles, while the FEC-SPE showed good 1st cycle CE of 92.1%, and the average CE from 2nd to 96^{th} cycles reached 97.6%. This value is lower than that measured under the PNNL protocol (99.0%) because the huge volume change of lithium metal anode may lead to the break and reconstruction of SEI during each cycle.

FIG. 16H shows the evolution of electrochemical impedance spectroscopy (EIS) when cycling a Li∥FEC-SPE∥Li symmetric cell. A low and constant charge transfer resistance (R_{ct}) ˜70 ohm×cm² was observed after 18 hours, suggesting intimate electrode-electrolyte contact as well as the formation of a stable and conductive SEI layer. The voltage-time profile during EIS measurement was shown in FIG. 21. The overpotential gradually decreased from ˜40 mV to 25 mV, which is in accordance with the decreased interfacial resistance over time. The decrease in interfacial resistance during the first several hours could be due to the formation of a LiF-rich SEI layer. For comparison, the interfacial resistance evolution of SN-SPE was also measured. As shown in FIGS. 5A and 5B, obvious increase in bulk resistance and interfacial resistance could be observed. This suggests decreased SPE conductivity as well as generation of a non-conductive interface due to the side reaction between SN and lithium metal. The low Rot of FEC-SPE outperformed most existing SPEs, and is also in sharp contrast to the inorganic electrolytes where high stacking pressure, high testing temperature, or extra interfacial layer are required to mitigate their interfacial issues. In contrast, the excellent electrochemical performance of FEC-SPE here was obtained at r.t. under low stacking pressure (crimping pressure is lower than 8 MPa) without a host matrix for Li or an interfacial layer.

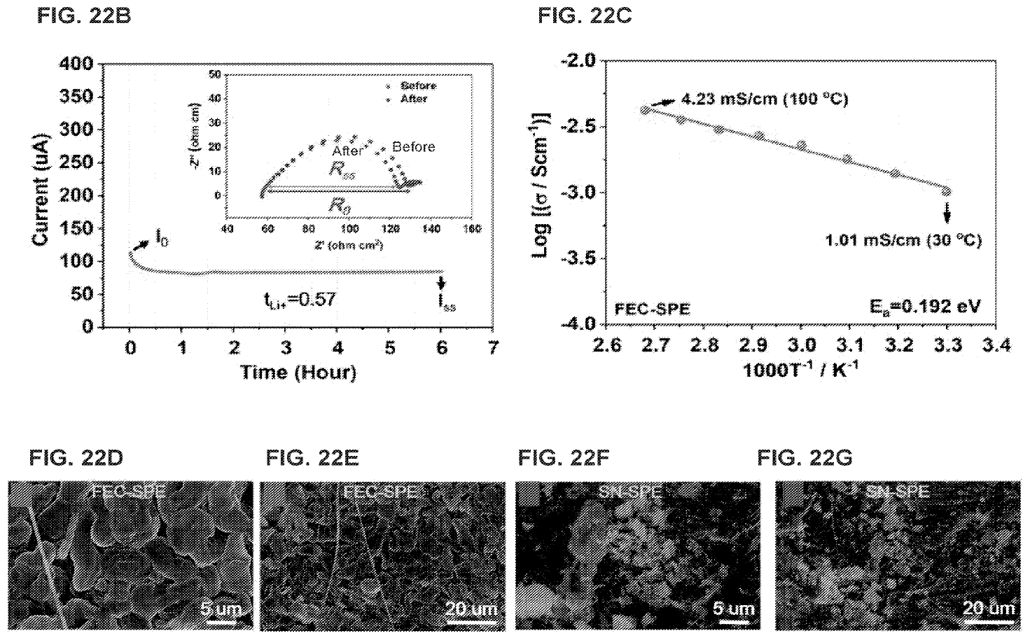

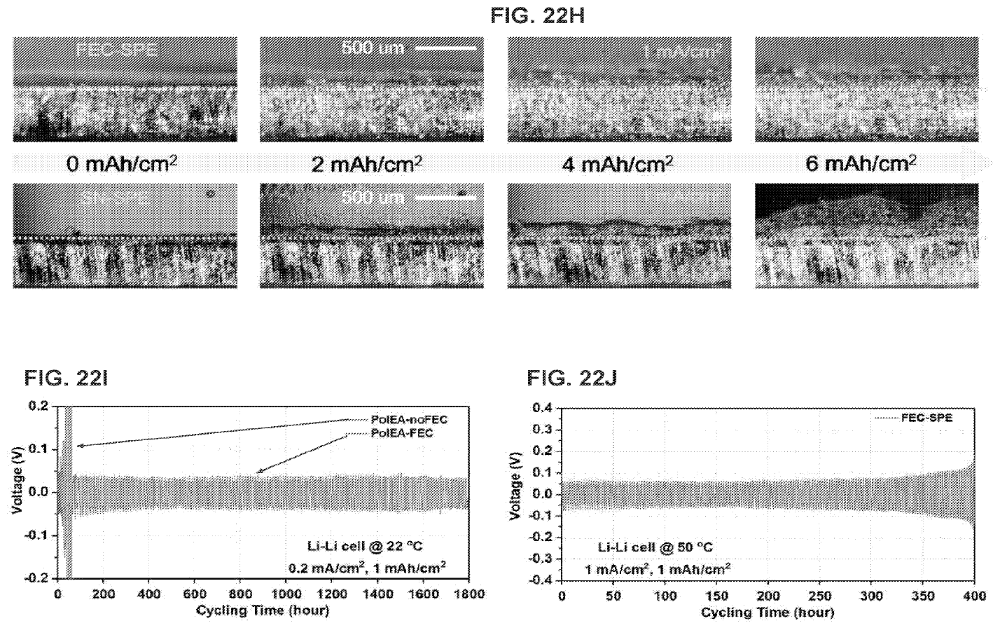

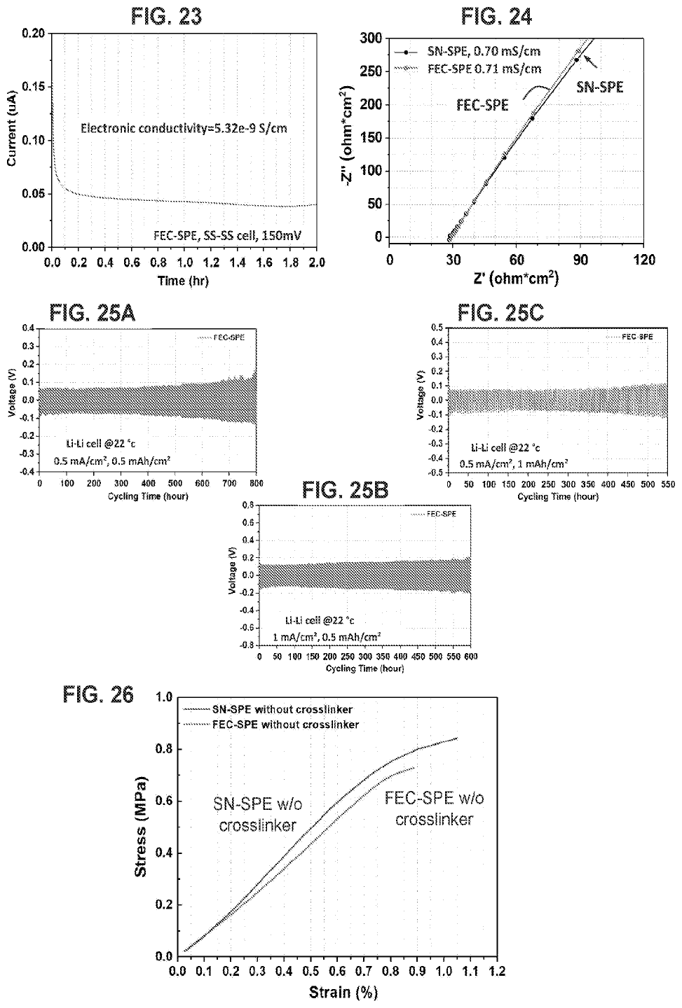

FEC-SPE's interfacial stability against Li⁰ was further examined under a large areal capacity condition close to practical operations. When continuously charging a Li∥FEC-SPE∥Li cell up to 3.6 mAh/cm² at 0.2 mA/cm², the cell reached a voltage plateau at 33 mV after SEI forming process in the first 4 hours (FIG. 22A). The low overpotential suggests suppressed dendrite formation, minimized side reaction, and no delamination, which is consistent with the observation in TEM (FIGS. 2A-2C). As discussed above, electrochemically, this low overpotential is attributed to the low Rat, high ionic conductivity, low electronic conductivity (FIG. 23, 5.32e-9 S/cm), and good transference number (0.57, FIG. 22B) of FEC-SPE.

As seen in FIG. 22C, the conductivity of FEC-SPE obeys the Arrhenius law in the temperature range from 30° C. to 100° C. A low activation energy of 0.19 eV suggests a low activation barrier of Li+ conduction and enables a high conductivity of 1.01 mS/cm at 30° C. In addition, the Arrhenius type ion conduction mechanism (other than VTF expression) also suggests the decoupling of ion conduction with the chain relaxation and segmental motion due to the high crosslinking degree and the lower solvating ability of polyacrylate towards Li⁺. The SN plasticizer as Li⁺ solvation moieties are sufficiently mobile to assist ion migration along the polyacrylate chains, namely, the solvated Li⁺ diffuse through the SN/LiTFSI phase within the material, and at the interface, the desolvated or partially desolvated Li⁺ then migrate through the SEI and get reduced to Li⁰.

FIG. 24 compared the r.t. conductivity (22° C.) of FEC-SPE and SN-SPE. Their similar conductivity (0.70 mS/cm vs 0.71 mS/cm) suggests that the addition FEC does not obviously change the conductivity of SPE, and the improvement in battery performance should be attributed to the improved interfacial stability. Namely that the stable Li⁰ plating overpotential can be attributed to the conformal Li⁰ growth under the confinement of the well-engineered SEI. Correspondingly, the SEM image of Li⁰ plated in FEC-SPE (2 mAh/cm²) reveals a dendrite/whisker-free morphology comprising of large size lithium columns up to 10 μm in diameter (FIGS. 22D and 22E), while SN-SPE resulted in a porous and mossy lithium morphology (FIGS. 22F and 22G). For comparison, the SEM images of pristine lithium metal displayed a smooth and flat surface (FIG. 11), which is quite different from the morphology of the plated lithium metal in SN-SPE or FEC-SPE.

In-situ optical cells were assembled to visualize the morphology evolution during lithium plating at 1 mA/cm² in operando. The Li⁰ derived from SN-SPE is non-uniform, loose, and porous (FIG. 22H), implying a dendritic and uncontrolled lithium growth. In contrast, FEC-SPE has enabled a more uniform and conformal morphology of Li⁰. The lithium metal gradually became thicker with a step-up capacity of up to 6 mAh/cm². The shiny color indicates Li⁰ deposition with little side reaction, and the smooth lithium surface suggests an inhibited dendritic growth. On the other hand, the dark color of plated filaments in SN-SPE indicates corrosion on plated Li⁰. When cycling with pristine Li⁰ at 1 mAh/cm², the cell using SN-SPE failed within 100 hours due to rapid overpotential build-up (FIG. 22I), while FEC-SPE enabled stable cycling for 1800 hours at 22° C. (r.t.). Furthermore, the FEC-SPE based symmetric cell is capable of cycling at 1 mA/cm², 1 mAh/cm² for 400 hours (FIG. 22J) and 0.5 mA/cm², 0.5 mAh/cm² for 800 hours (FIG. 25A).

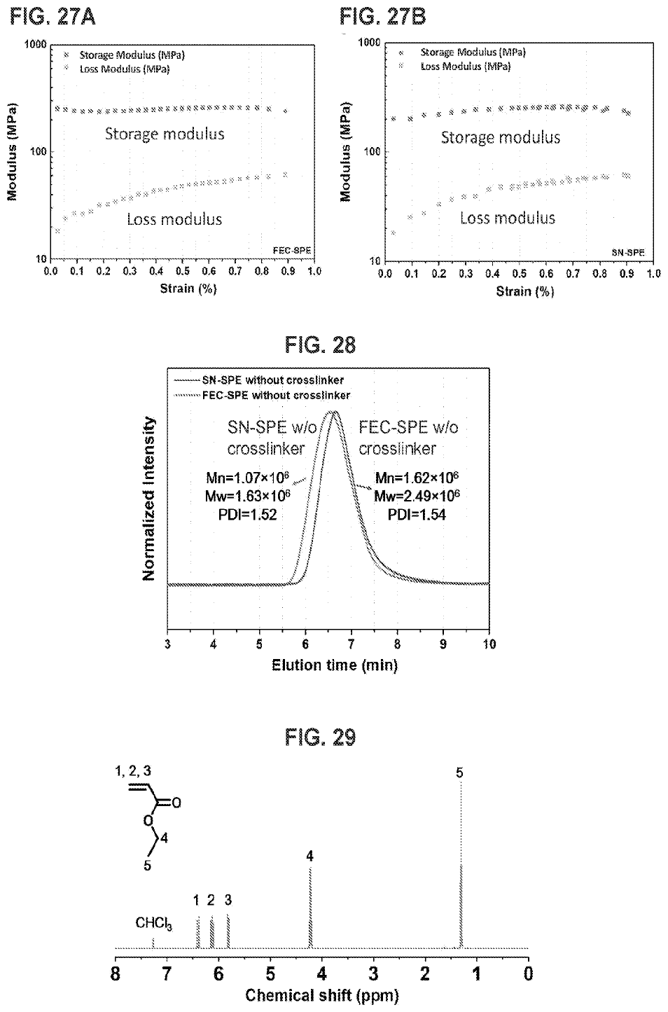

To decouple the improved electrochemical stability with other SPE properties such as rheology properties and molecular weight distribution, the mechanical properties of SN-SPE and FEC-SPE were examined using dynamic mechanical analysis. FIG. 26 showed that FEC-SPE and SN-SPE have a similar tensile strength of 0.7 MPa and 0.8 MPa, respectively. Their storage moduli were both between 200-300 MPa (FIGS. 27A and 27B). FEC-SPE and SN-SPE displayed low loss modulus in the range of 20-60 MPa, suggesting their solid nature. Furthermore, the molecular weight and polydispersity index (PDI) of the prepared SPEs were measured. Note that in FIG. 28, both the SN-SPE and FEC-SPE samples were prepared without EDA crosslinker to obtain a soluble sample for gel permeation chromatography (GPC) measurement. The two SPEs showed similar and high molecular weight of 1.07×10⁶ Da and 1.62×10⁶ Da, respectively. Their similar PDI of 1.52 and 1.54 also suggest that the addition of FEC does not obviously change the polymerization chemistry of SPE. Finally, the monomer conversion yield was measured by the liquid-state 1H NMR technique (see FIGS. 10A, 10B and 29), both SN-SPE and FEC-SPE showed almost quantitative monomer conversion yield and the residual oligomers could not be detected.

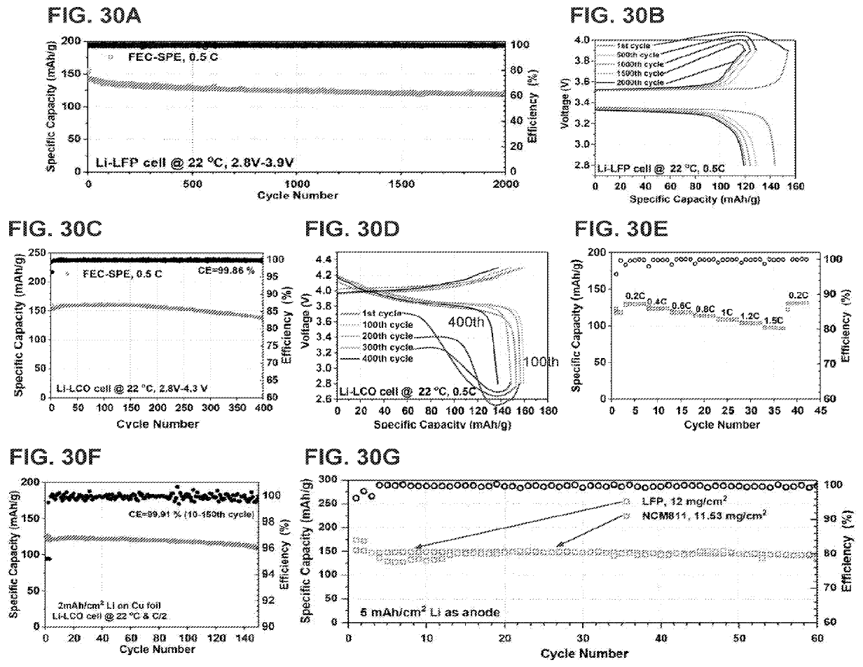

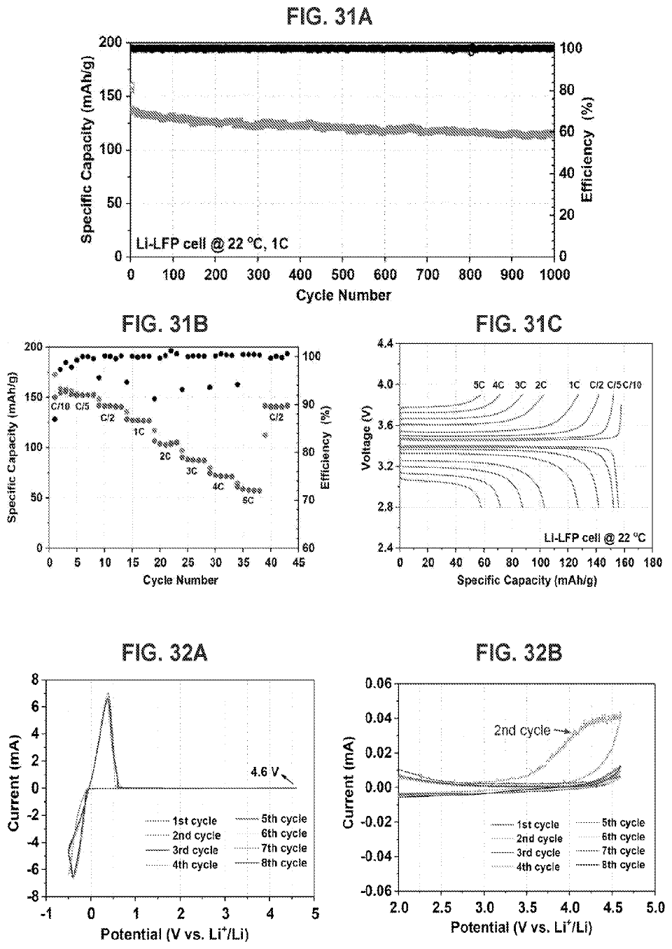

Solid-state full cells were assembled using LiFePO₄ cathode (˜0.3 mAh/cm²) and excess lithium metal as anode. The LiFePO₄∥FEC-SPE∥Li full cell achieved a high capacity retention of 83% at 0.5 C rate and 22° C. after 2000 cycles (FIG. 30A, ˜5000 hours, 0.011% decay/cycle). The low and constant overpotential (0.13 V) as shown in the charge-discharge curves suggests the excellent interfacial stability of FEC-SPE with both the LiFePO₄ cathode and the Li⁰ anode (FIG. 30B). The 1 C (0.3 mA/cm²) cycling performance and rate capability of the Li-LFP battery at r.t. is provided in FIGS. 31A-31C. After 1000 cycles at r.t., the capacity only decreased from 138 mAh/g to 116 mAh/g. At a low current density of 0.2 C, the cell showed good capacity >150 mAh/g. At high current density of 5C, a capacity of 60 mAh/g could be maintained.

Prior to testing the performance of FEC-SPE with high voltage cathode materials, its electrochemical stability window was firstly determined by cyclic voltammetry (CV). FIG. 32A depicted the 1^{st} to 8^{th} CV scanning cycles of a Li∥FEC-SPE∥SS cell. At a low potential region, the Li⁰ oxidation current and Li⁰ reduction current remained unchanged with increasing scanning numbers, suggesting excellent reversibility of the Li⁰ stripping/plating process, i.e. minimized side reactions. At a high potential region as shown in FIG. 32B, the SPE oxidation current generally decreased with increasing scanning numbers. The small anodic current suggests the excellent anti-oxidation stability of SPE at high voltage range.

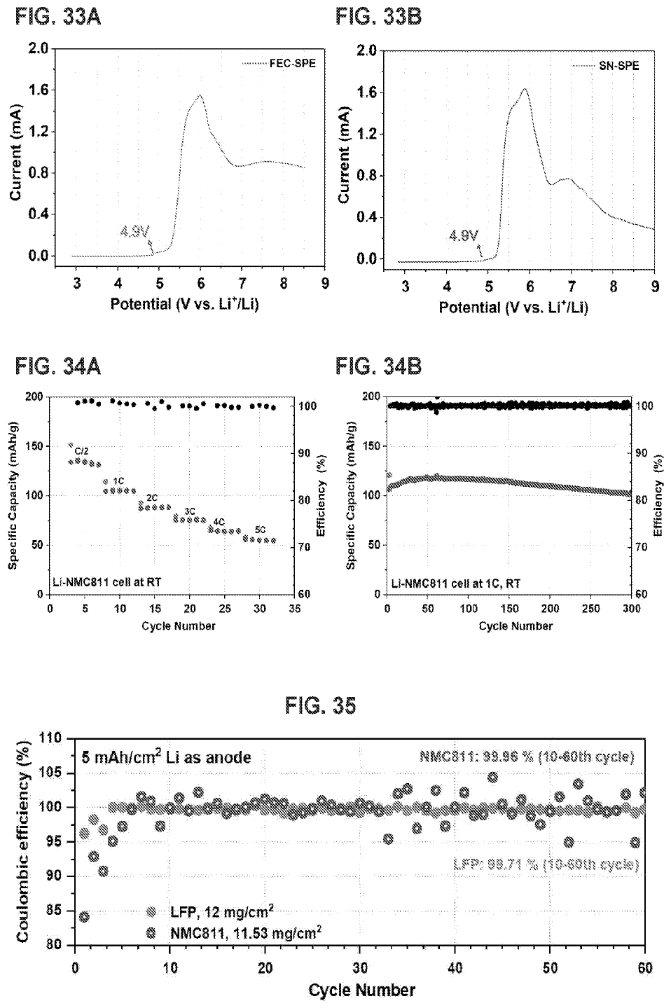

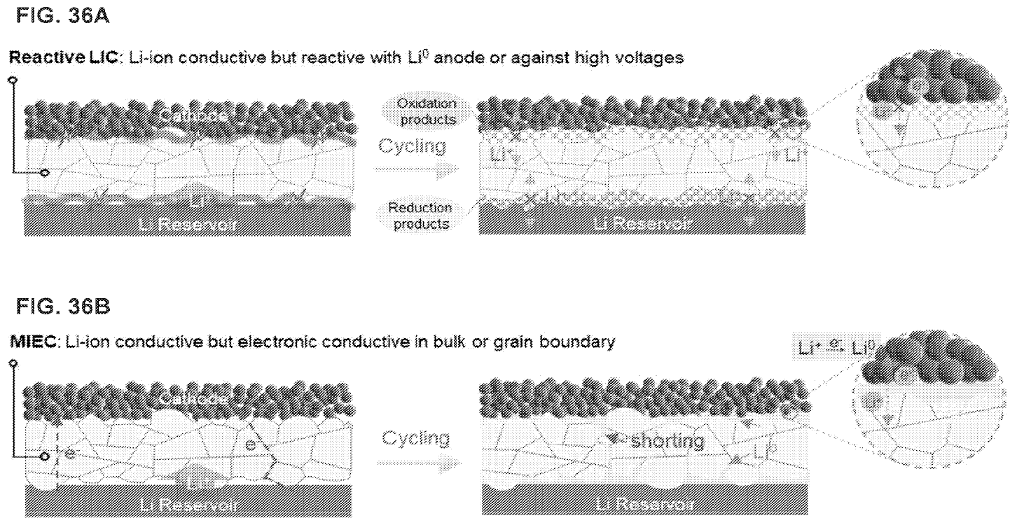

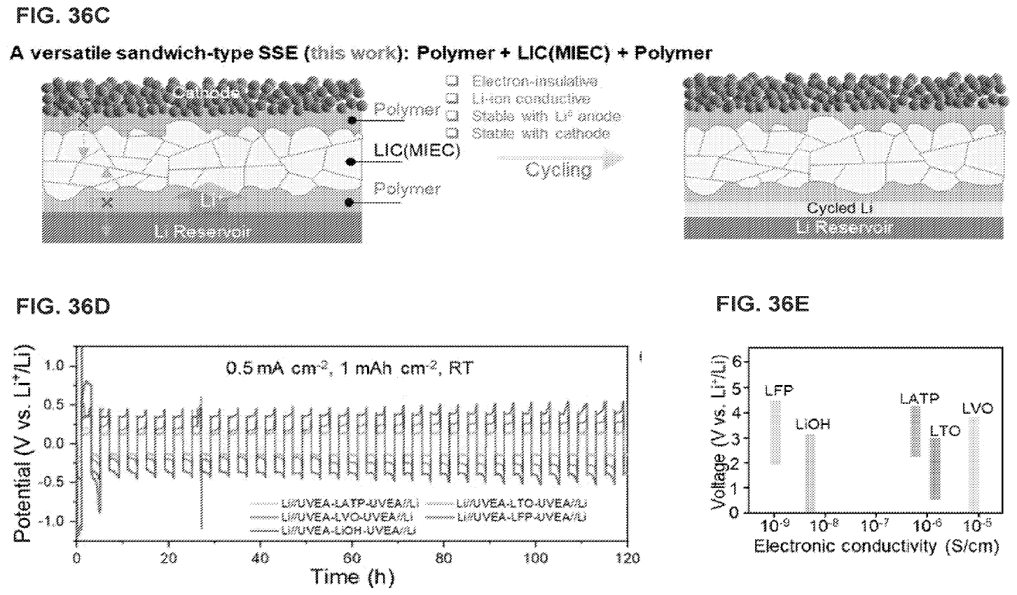

The electrochemical stability window of prepared SPE using LSV was further determined. It could be seen from FIGS. 33A and 33B that both FEC-SPE and SN-SPE showed onsite SPE oxidation potential ˜4.9 V. For comparison, the PEO-SPE has been documented to be electrochemically unstable at voltages >3.8 V. Without wishing to limit the invention to a particular theory or mechanism, the extended electrochemical stability window of prepared SPE may be due to the high anti-oxidation ability of both polyacrylate backbone and SN plasticizer.

Owing to the wide electrochemical window of FEC-SPE (4.6 V vs Li⁺/Li), solid-state cells with high-voltage LiCoO₂ cathode (0.6 mAh/cm²) showed a stable capacity ˜150 mAh/g for >400 cycles at 0.5 C (FIGS. 30C and 30D) with 2.8-4.3 V voltage cutoffs. The Li∥FEC-SPE∥LiCoO₂ cell also showed excellent rate capability and delivered a high capacity of ˜100 mAh/g at 1.5 C charge/discharge rate (FIG. 30E). The capacity was restored to 130 mAh/g when the current density switched back to 0.2 C, demonstrating good reversibility when using the FEC-SPE with a high voltage cathode. The rate capability and cycling performance of Li-NMC811 cells were further provided in FIGS. 34A and 34B. The Li-NMC811 batteries deliver a capacity of 135 mAh/g at 0.5 C and RT. When the current density increases to 5 C, the cell maintains a capacity of 55 mAh/g. In addition, when cycling at 1 C and RT, the cell shows an initial capacity of 109 mAh/g. After 300 cycles, the capacity of 101 mAh/g could be maintained.

To further demonstrate the application of FEC-SPE at the cell level, a low N/P ratio Li—LiCoO₂ battery with 2 mAh/cm² lithium metal as the anode and 0.77 mAh/cm² LiCoO₂ as the cathode was assembled. The cell was cycled at 0.5 C and the capacity was maintained at ˜125 mAh/g for 140 cycles, and the averaged CE from the 10-150^{th} cycle reached 99.91%. (FIG. 30F). To further evaluate the performance of FEC-SPE under more realistic conditions, commercial high areal capacity LiFePO₄ cathode (2 mAh/cm²) was paired with a 5 mAh/cm² lithium metal anode, and the as-assembled solid-state battery using FEC-SPE was tested at 22° C. and 0.2 C. The capacity only slightly decreased from 151.2 mAh/g to 141.2 mAh/g after 60 cycles (FIG. 30G). Furthermore, the low N/P ratio cell with commercial thick NMC811 cathode (2.3 mAh/cm²) could also deliver a stable capacity of ˜150 mAh/g for 60 cycles. In addition, the averaged CE for the low NP ratio Li—LiFePO₄ cell and Li-NMC811 cell are 99.71% and 99.96% (FIG. 35), respectively, further demonstrated the stable interface induced by the FEC additive. The full cell capacity and cyclability may be further improved by using a modified cathode and/or Li⁰ anode, such as using surface coated or doped layered cathode materials and/or introducing artificial SEI on the Li⁰ anode.

The present invention uncovered a degradation mechanism of Li⁰ anode which has not been reported before. Without wishing to limit the invention to a particular theory or mechanism, a lack of a stable SEI, Li⁰ anode could degrade due to stress corrosion induced by side reactions and volume change. By using cryoEM imaging and spectroscopic techniques, the structure/chemistry of solid electrolyte interfaces between the solid polymer electrolyte and Li⁰ anode was investigated. The inventor successfully developed a novel SPE by additive engineering to control the SEI formation and finally demonstrated the application of novel FEC-SPE in full cells with long cycle life (>2000 cycles), high current density, and high areal capacity. The FEC additive in the solid polymer electrolyte could result in an F-rich SEI primarily containing disordered/amorphous F-related species, which could play a vital role in improving the reversibility of Li⁰ anode. This work also provided a new design strategy for solid polymer electrolytes, which is to control the SEI by additive engineering.

EXAMPLE 2—The following is a non-limiting example of the present invention. It is to be understood that said example is not intended to limit the present invention in any way. Equivalents or substitutes are within the scope of the present invention.

### Fabrication and Characterization of Sandwich SSE

The UVEA film was prepared by the method described herein. The inorganic LATP layer was produced by pressing the commercial fine LATP powders into round pellets followed by annealing at 1150° C. The as-fabricated LATP pellets with a thickness around 0.5 mm had a dense and uniform surface morphology, which is beneficial from the high-temperature welding process. The inorganic LVO layer was fabricated using the similar pressing method yet without annealing, in which the LVO powders were synthesized through a sol-gel method adapted from previous methods. Robust LVO pellets with grainy and smooth surface can be directly obtained via the cold-pressing protocol, largely owing to the small particle size.

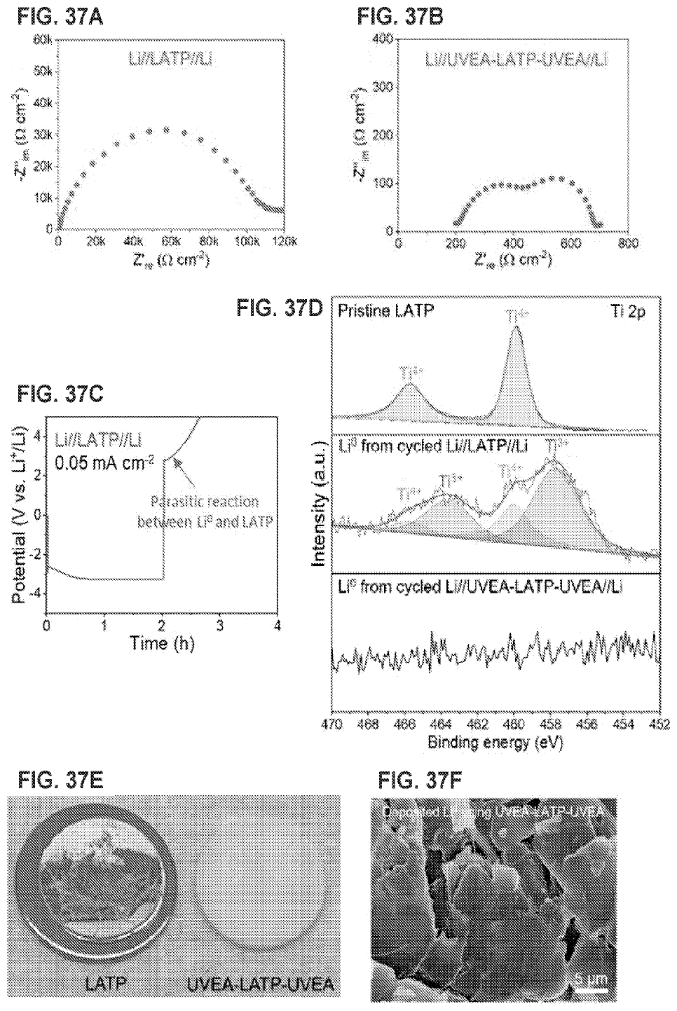

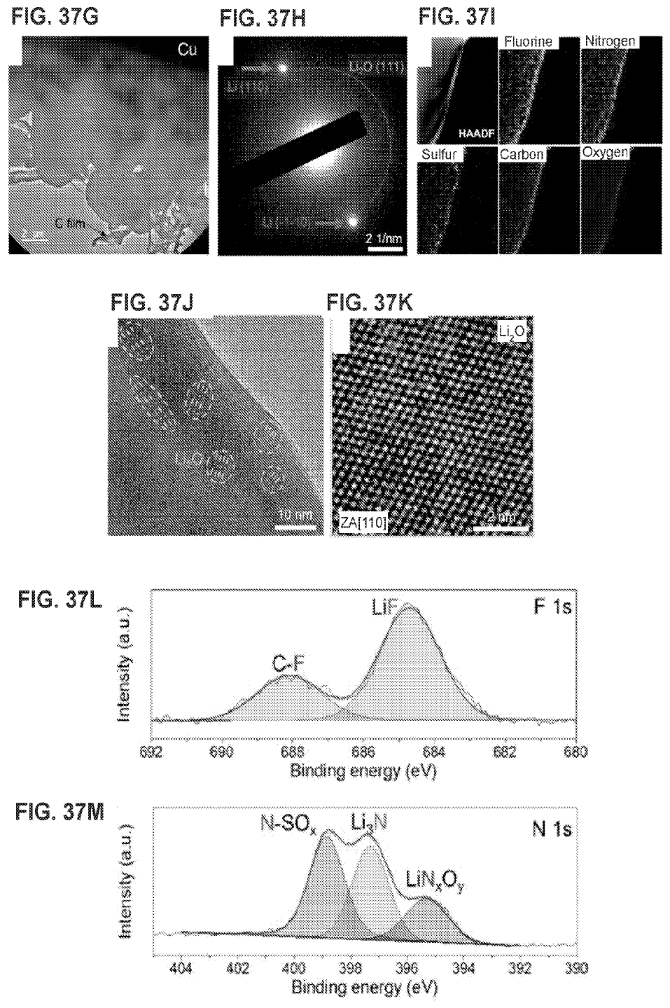

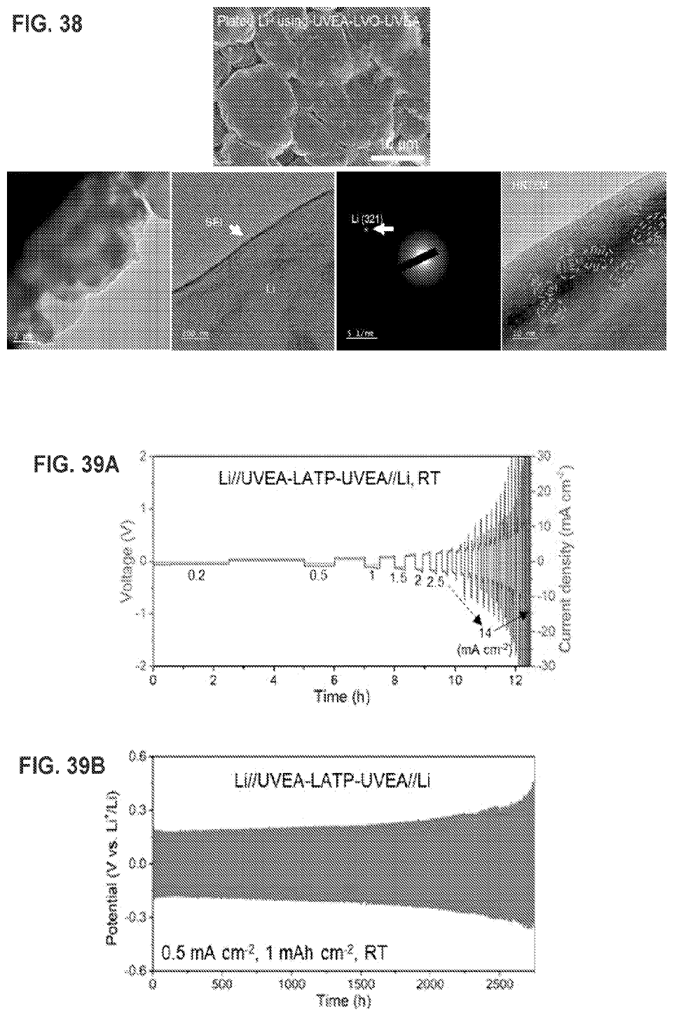

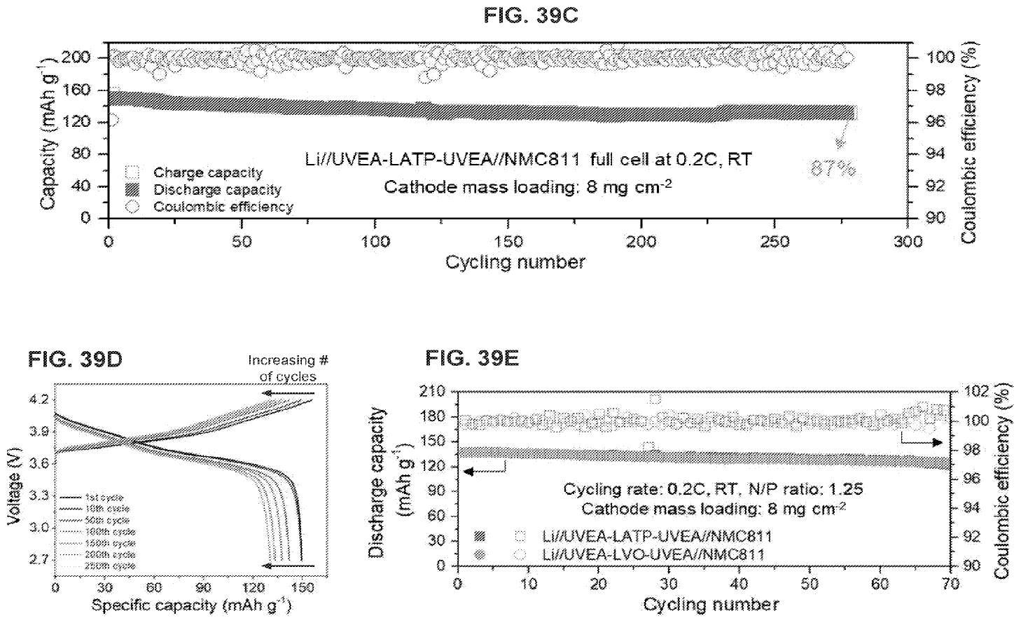

The versatility of sandwich-type SSE was examined first using LATP as the inorganic LIC component, in which LATP is a popular but representative LICs that is unstable against Li reduction. FIGS. 37A-37B show the impedance result of fresh symmetric Li//Li cells using baseline LATP and sandwich UVEA-LATP-UVEA as the SSE. It indicates that bare LATP-based cell presents a huge interfacial resistance at the magnitude of 105 ohm cm⁻², while the UVEA-LATP-UVEA-based cell delivers much lower interfacial resistance and charge-transfer resistance. This is strong evidence that UVEA film can effectively protect LATP from reduction reaction, which was further confirmed by the XPS analysis (FIG. 37D). The Ti 2p XPS spectra reveal that the cycled Li⁰ electrode from Li//UVEA-LATP-UVEA//Li shows no apparent Ti signal. In contrast, there was a well-recognized Ti signal on the Li⁰ electrode when cycling using bare LATP, which can be further deconvoluted into Ti³⁺ and Ti⁴⁺. The appearance of Ti³⁺ signal correlates well with the LATP reduction. The protection of UVEA film was also validated by the color change of LATP pellets with/without UVEA film after cycling in symmetric Li//Li cells (FIG. 2E), where bare LATP turns into black while UVEA-wrapped LATP maintains the original light yellow color.

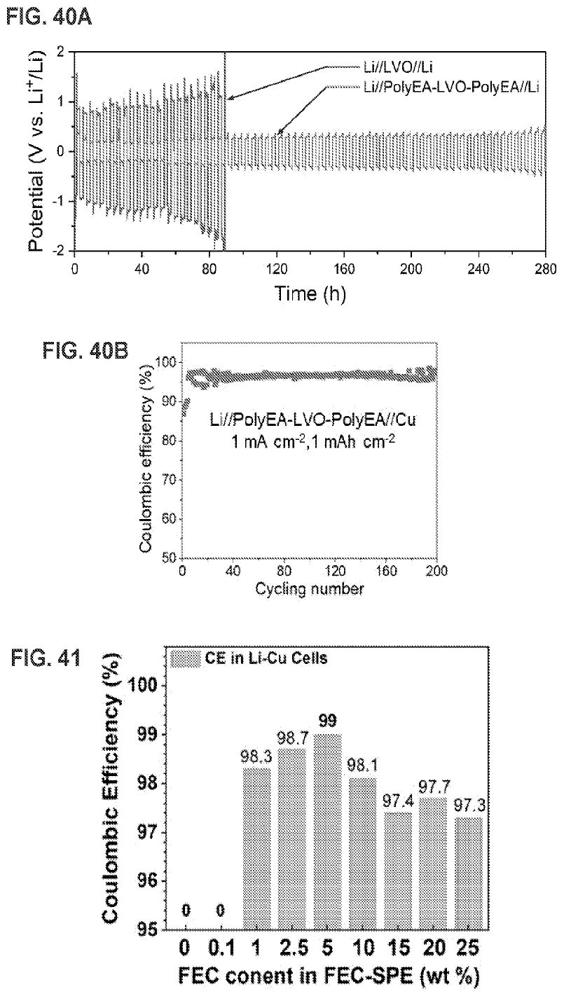

Lithium vanadium oxide (LVO) is a mixed ionic electronic conductor. It is not a good insulator. As shown by the cycling data of the Li//LVO//Li cell in FIG. 40A, the cell shorts very quickly. As shown in FIG. 40B, the Li//PolyEA-LVO-PolyEA//Li cell can cycle much longer.

In a recent report in Nature, Xin Li et al. disclosed a sandwich structure of Li_{5.5}PS_{4.5}Cl_{1.5} (LPSCI) inorganic electrolyte #1 and Li₁₀Ge₁P₂S₁₂ (LGPS) inorganic electrolyte #2. Electrolyte #2 is sandwiched between two layers of electrolyte #1. Xin Li et al. claimed that electrolyte #1, LPSCI, is more stable with lithium but prone to dendrite penetration. Electrolyte #2, LGPS, is less stable with lithium but appears immune to dendrites. Compared with Xin Li et al.'s design, the polymer|ceramic∥polymer sandwich structure of the present invention has the following advantages:

1) Because polymers are soft, they serve as a layer to improve the contact between the electrolyte and the electrodes. In the polymer sandwich, a stacking pressure of less than 8 MPa is needed, as opposed to >40 MPa in the full ceramic sandwich.

2) For the ceramic sandwich to work in a Li-anode battery, an additional Igraphite layer of 40 to 100 micron thick is needed. This layer is needed to prevent Li from meeting electrolyte #1, LPSCI because Li and LPSCI spontaneously react with each other and the interphase is unfavorable—i.e. high impedance. In the polymer sandwich, this thick graphite layered is not needed because the polymers can passivate the Li-Polymer interface and prevent impedance rise.

3) Xin Li et al. does not use mixed electronic ionic conductors. All inorganic electrolytes in the 3-layer sandwich structure are electronic insulators. This broadened inclusion of mixed electronic ionic conductors in the polymer sandwich is novel and non-trivial.

As used herein, the term “about” refers to plus or minus 10% of the referenced number. Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

1. A solid state battery comprising an anode, a cathode, and a solid polymer electrolyte (SPE), wherein the SPE comprising a polymerized product of:
a. a polymer backbone comprising poly(ethylacrylate) or polyacrylonitrile; and
b. a salt ionizing and Li conducting plasticizer comprising succinonitrile.

2. The battery of claim 1, wherein the SPE further comprises about 1 wt % to about 50 wt % of an electrolyte additive, wherein the electrolyte additive comprises fluoroethylene carbonate (FEC) or a combination of FEC and vinylene carbonate.

3. (canceled)

4. (canceled)

5. The battery of claim 1, wherein the SPE further comprises a Li salt, wherein the Li salt is LiTESI.

6. (canceled)

7. (canceled)

8. The battery of claim 1, wherein the SPE has a storage moduli in a range of about 200-300 MPa.

9. The battery of claim 1, wherein the SPE has a loss modulus in a range of about 20-60 MPa.

10. The battery of claim 1, wherein a thickness of the SPE is in a range of about 5-400 μm.

11. The battery of claim 1, wherein the anode comprises Li metal, graphite, silicon, Li₄Ti₅O₁₂ or combinations thereof.

12. The battery of claim 1, wherein the cathode comprises LiFePO₄, LiCoO₂, LiNiₓMn_{y}CO_{1-x-y}O₂ (NMC) with x ranging from 0.33 to 1 and y ranging from 0 to 0.4, layered oxide cathodes, Li—Mn-rich cathodes, conversion cathodes, or derivatives thereof.

13. The battery of claim 1, wherein a Coulombic efficiency of the battery is at least 98%.

14. (canceled)

15. A solid-electrolyte interphase (SEI) film, the SEI film comprising a polymerized product of:
a. a polymer backbone comprising poly(ethylacrylate) or polyacrylonitrile; and
b. a salt ionizing and Li conducting plasticizer for a solid state battery comprising succinonitrile.

16. The SEI film of claim 15, further comprising about 1 wt % to about 50 wt % of an electrolyte additive, wherein the electrolyte additive comprises fluoroethylene carbonate (FEC) or a combination of FEC and vinylene carbonate.

17. (canceled)

18. (canceled)

19. The SEI film of claim 16, further comprising a Li salt, wherein the Li salt is LiTFSI.

20. (canceled)

21. The SEI film of claim 15, wherein the film is disposed on a surface of an anode, wherein the anode comprises Li metal, graphite, silicon, Li₄Ti₅O₁₂ or combinations thereof.

22. (canceled)

23. (canceled)

24. The SEI film of claim 21, wherein a thickness of the SEI film disposed on the surface of the anode ranges from about 1-30 nm.

25.-37. (canceled)

38. A solid electrolyte separator for a solid state battery, the separator comprising a ceramic layer juxtaposed between two polymer layers, the polymer layers comprising a polymerized product of:
a. a polymer backbone comprising poly(ethylacrylate) or polyacrylonitrile; and
b. a salt ionizing and Li conducting plasticizer comprising succinonitrile.

39. The separator of claim 38, wherein the polymer layers further comprises about 1 wt % to about 50 wt % of an electrolyte additive, wherein the electrolyte additive comprises fluoroethylene carbonate (FEC) or a combination of FEC and vinylene carbonate.

40. (canceled)

41. (canceled)

42. The separator of claim 38, wherein the polymer layers further comprises a Li salt, wherein the Li salt is LiTFSI.

43. (canceled)

44. The separator of claim 38, wherein the polymer layers are electron-insulative.

45. The separator of claim 38, wherein the ceramic layer has Li ion conductivity.

46. (canceled)

47. The separator of claim 38, wherein the ceramic layer comprises Li₁₊ₐAlₐTi₂₋ₐ(PO₄)₃ (LATP) with 0≤a≤0.7, Li_{1+b}Al_{b}Ge_{2-b}(PO₄)₃ with 0≤b≤1.5, LiV₃O₈ (LVO), Li₇La₃Zr₂O₁₂ (LLZO), Li₇La₃Zr_{2-c}Ta_{c}O₁₂ (LLZTO) with 0≤c≤2, LiOH, lithium nitride, lithium titanium oxide, lithium iron phosphate, Li₁₀GeP₂S₁₂ (LGPS), Li₇P₃S₁₁ (LPS), Li₆PS₅Cl, or derivatives or combinations thereof.

48.-74. (canceled)
